(19) United States
(12) Patent Application Publication
(10) Pub. No.: US 2023/0249988 A1
(43) Pub. Date: Aug. 10, 2023

(54) Water Filtration System, and Associated Method

(71) Applicant: Cloud Water Filter, LLC, San Diego, CA (US)

(72) Inventors: Douglas Marsden, Marblehead, MA (US); Andrew A. Panasyuk, Somerville, MA (US); Michael McDuffee, Gloucester, MA (US); Marc Halliwell Senger, Plymouth, MA (US); Benjamin J. Beck, Boston, MA (US); Benjamin Zvaifler, San Diego, CA (US)

(21) Appl. No.: 18/124,920

(22) Filed: Mar. 22, 2023

Related U.S. Application Data
(63) Continuation-in-part of application No. 18/166,865, filed on Feb. 9, 2023.
(60) Provisional application No. 63/341,902, filed on May 13, 2022.
(60) Provisional application No. 63/308,322, filed on Feb. 9, 2022.

(51) Int. Cl. C02F 1/00; C02F 9/00; B01D 61/02; B01D 61/04; B01D 61/08; B01D 61/12

(52) U.S. Cl. CPC C02F 1/008; C02F 9/00; B01D 61/025; B01D 61/04; B01D 61/081; B01D 61/12; C02F 2209/008; C02F 2209/03; C02F 2209/40; C02F 1/441

(57) ABSTRACT

A method including determining a first value associated with a first component of a water filtration system using a first sensor of the water filtration system, determining whether the first component is degraded based on the first value, and in response to determining that the first component is degraded, initiating a shipment of a replacement component.

### CROSS-REFERENCE TO RELATED APPLICATIONS

This claims the benefit of U.S. Provisional Application No. 63/341,902, filed May 13, 2022 and is also is a continuation-in-part of U.S. patent application Ser. No. 18/166,865, filed Feb. 9, 2023, which claims the benefit of U.S. Provisional Application No. 63/308,322, filed on Feb. 9, 2022, which application are all hereby incorporated herein by reference.

### TECHNICAL FIELD

The present disclosure relates generally to an electronic system and method, and, in particular embodiments, to a water filtration system, and associated method.

### BACKGROUND

Water may contain impurities that affect the water quality, e.g., for drinking purposes. A water filter removes impurities, e.g., using mechanical, chemical, and/or biological processes. A drinking water filtration system, e.g., for home use, may include one or more stages utilizing different processes for improving the quality of water for human consumption. For example, FIG. 1 shows a block diagrams of exemplary reverse osmosis (RO) filtration systems 100. RO filtration system 100 includes sediment filtration stage 102, carbon filtration stage 104, RO filtration stage 106, and post-filter stage (108).

Sediment filtration stage 102 generally includes a physical membrane for removing impurities, such as dirt, rust, and suspended particles.

Carbon filtration stage 104 generally includes a carbon substrate that removes impurities such as chlorine, volatile organic compounds (VOCs) by adsorption. The carbon filtration stage 104 may also help in protecting the RO membrane of the RO filtration stage 106.

RO filtration stage 106 generally includes an RO membrane that separate ions, unwanted molecules, and large particles from drinking water. For example, RO filtration stage 104 may remove fluoride, lead, arsenic, and other minerals from the drinking water. The removed impurities are discarded as wastewater, e.g., into the drain.

Post-filter stage 108 may include a post-carbon media and a remineralization media. The post-carbon media of stage 108 may remove residual chlorine, and other remaining organic particles and may enhance the taste of the filtered water. The remineralization media of stage 108 generally introduces back into the drinking water minerals that are beneficial for human consumption, such as calcium, magnesium, sodium, potassium, etc. The output of the remineralization stage is, e.g., delivered to a faucet.

When system 100 is implemented without the remineralization media and is operating properly, filtered water (e.g., at the output of stages 102, 104, 106 or 108) has less impurities than the input water. Impurities in water may be measured using a total dissolved solids (TDS) sensor in ways known in the art and may be reported in TDS ppm. Thus, when system 100 is operating properly, the filtered water has less TDS ppm than the input water.

When system 100 is implemented with the remineralization media, the water at the output of stage 108 may have higher TDS ppm than the water at the input of stage 108.

Stages 102, 104, 106, and 108 are generally implemented as cartridges that can be attached or detached (e.g., for replacement purposes) from the filtration system.

FIG. 2 shows a block diagrams of exemplary RO filtration systems 200. RO filtration system 200 operates in a similar manner as RO filtration system 100. RO filtration system 200, however, includes water storage tank 202 for storing drinking water.

RO filtration systems without a water storage tank (such as RO filtration system 100) may require a booster pump for pushing water through the filtration stages and thus may need to be powered by mains. RO filtration systems with a water storage tank (such as RO filtration system 200) may operate using the water pressure from the input water to fill the water storage tank 202, and thus may advantageously avoid being powered by mains.

RO filtration systems such as 100 and 200 may be intended to be used under the sink.

FIG. 3 shows additional details of exemplary 4-stage under-the-sink RO system 200. As shown in FIG. 3, a housing 302 receives input water and provides drinking water. Stages 1-4 are screwed into housing 302. Housing 302 includes water tubing for routing water into and out of the water filter stages (e.g., 102, 104, 106, 108) and water storage tank 202. Housing 302 is generally attached to a wall/panel in a cabinet under the kitchen sink.

The process of replacing water filters (e.g., 102, 104, 106, and 108) typically involves: turning off the input water; removing the water filter to be replaced by unscrewing the water filter from housing 302; screwing the new water filter into housing 302; and turning on the input water.

RO system 200 operates using the water pressure, does not include any electronics, and is not powered by mains.

### SUMMARY

In accordance with an embodiment, a method includes determining a first value associated with a first component of a water filtration system using a first sensor of the water filtration system. It is determined whether the first component is degraded based on the first value, and in response to determining that the first component is degraded, shipment of a replacement component is caused.

In accordance with an embodiment, a water filtration system includes a plurality of cartridge receptacles for a plurality of cartridge. A first cartridge receptacle of the plurality of cartridge receptacles is configured to receive a water filter cartridge. A water storage tank is coupled to an output terminal of the water filtration system and a pressure sensor is coupled to the water storage tank and configured to determine a tank pressure of the water storage tank. A control circuit determines whether a first component is degraded based on the tank pressure of the water storage tank, where the first component comprises one of the plurality of cartridges or the water storage tank.

In accordance with an embodiment, a method of remotely maintaining a water filtration system, the method including: receiving data at a remote server, the data received directly from the water filtration system, the data including sensor information related to a component of the water filtration system, determining, by the remote server, that the component is degraded based on the sensor information, and in response to determining that the component is degraded, shipping a replacement component to a location of the water filtration system.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-3 show block diagrams of exemplary RO filtration systems;

FIG. 4A shows a front top perspective view of an RO filtration system, according to an embodiment of the present invention;

FIG. 4B shows a front top view of an RO filtration system, according to an embodiment of the present invention;

FIG. 4C shows a front top perspective view of an RO filtration system, according to an embodiment of the present invention;

FIG. 5A shows a rear top view of an RO filtration system, according to an embodiment of the present invention;

FIG. 5B shows a rear top view of an RO filtration system, according to an embodiment of the present invention;

FIG. 6A shows a rear bottom view of an RO filtration system, according to an embodiment of the present invention;

FIG. 6B shows a front bottom view of an RO filtration system, according to an embodiment of the present invention;

FIG. 7 shows a schematic diagram the RO filtration system of, e.g., FIGS. 4A-6B, according to an embodiment of the present invention;

FIG. 8 shows total volume of water versus pressure of the water storage tank, according to an embodiment of the present invention;

FIG. 9 shows a flow chart of an embodiment method for estimating the water stored in a water storage tank, according to an embodiment of the present invention;

FIG. 10 shows a flow chart of an embodiment method for determining the volume of water flowing through an RO filtration system, according to an embodiment of the present invention;

FIG. 11 shows a flow chart of embodiment an method for detecting water leakage in an RO filtration system, according to an embodiment of the present invention;

FIG. 12 shows a flow chart of an embodiment method for monitoring the health of a water storage tank, according to an embodiment of the present invention;

FIGS. 13-17 illustrate methods for the automatic shipment of replacement components of RO filtration system of FIGS. 4A-4C, according to embodiments of the present invention;

FIG. 18 shows a front view of an RO filtration system, according to an embodiment of the present invention;

FIG. 19 shows a back view of an RO filtration system, according to an embodiment of the present invention;

FIG. 20 shows a top view of an RO filtration system, according to an embodiment of the present invention;

FIG. 21 shows a bottom view of an RO filtration system, according to an embodiment of the present invention;

FIG. 22 shows a right side view of an RO filtration system, according to an embodiment of the present invention;

FIG. 23 shows a left side view of an RO filtration system, according to an embodiment of the present invention;

FIG. 24 shows a front perspective view of an RO filtration system, according to an embodiment of the present invention;

FIGS. 25A-25L show various other perspective views of an RO filtration system, according to an embodiment of the present invention;

FIG. 26 shows various views of the disassembled RO filtration system, according to an embodiment of the present invention;

FIGS. 27A-27C provide views showing how a RO filtration system can be disassembled, according to an embodiment of the present invention;

FIGS. 28A-28E show various views of an RO filtration system, according to an embodiment of the present invention;

FIGS. 29A and 29B show the inside of an RO filtration system, according to an embodiment of the present invention; and

FIGS. 30A and 30B show the system of FIGS. 29A-29B with the outside housing.

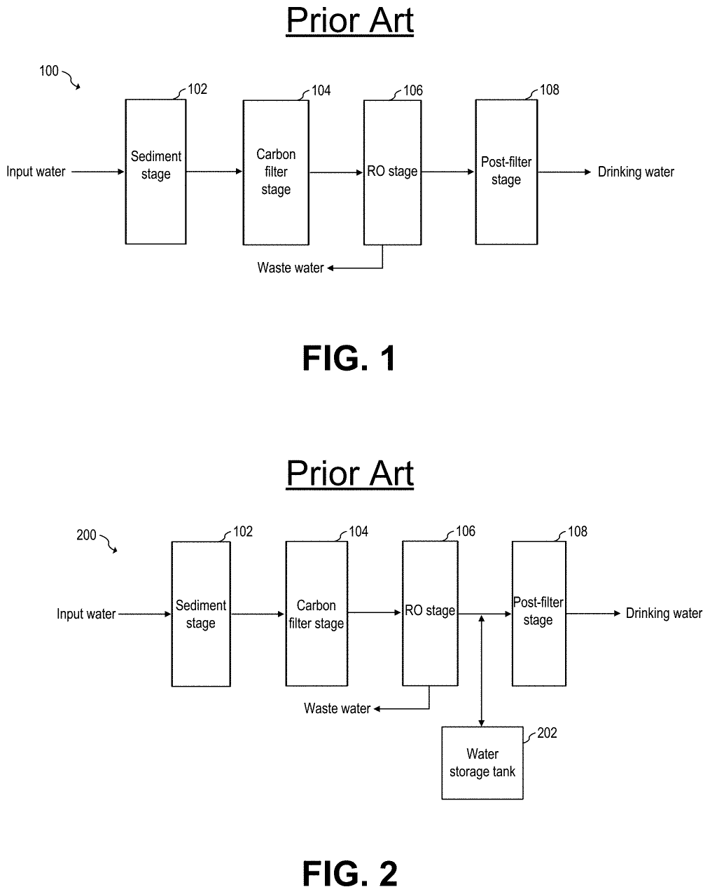

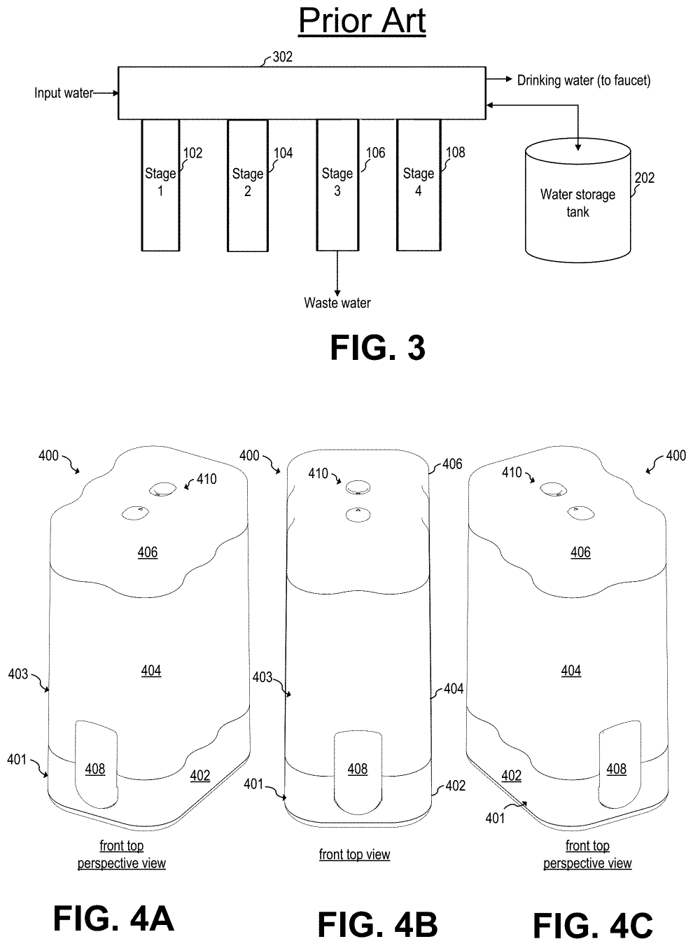

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The description below illustrates the various specific details to provide an in-depth understanding of several example embodiments according to the description. The embodiments may be obtained without one or more of the specific details, or with other methods, components, materials and the like. In other cases, known structures, materials, or operations are not shown or described in detail so as not to obscure the different aspects of the embodiments. References to “an embodiment” in this description indicate that a particular configuration, structure, or feature described in relation to the embodiment is included in at least one embodiment. Consequently, phrases such as “in one embodiment” that may appear at different points of the present description do not necessarily refer exactly to the same embodiment. Furthermore, specific formations, structures, or features may be combined in any appropriate manner in one or more embodiments.

Embodiments of the present invention will be described in specific contexts, e.g., an enclosed and detachable RO filtration system capable of determining the status of the RO filtration system (e.g., water quality, presence of faults, degradation of components, etc.), that automatically determines the need for component replacements (e.g., filter cartridges, battery, water tank) based on usage, and automatically requests shipment of a replacement component. Embodiments of the present invention may be used in other types of water filtration systems, such as non-RO systems, non-detachable systems, exposed systems, etc.

In an embodiment of the present invention, the status of an RO water filtration system (e.g., water quality, presence of faults, degradation of components, etc.) is determined based on outputs of one or more sensors (e.g., TDS sensors, a pressure sensor). Degradation of particular components (e.g., filter cartridge, battery cartridge, and/or a water storage tank) is determined based on a combination of usage factors and time. Shipment of a replacement component (e.g., filter cartridge, battery cartridge, and/or a water storage tank) is triggered based on the degradation of the component as well as on the degradation or replacement of other components of the RO water filtration system.

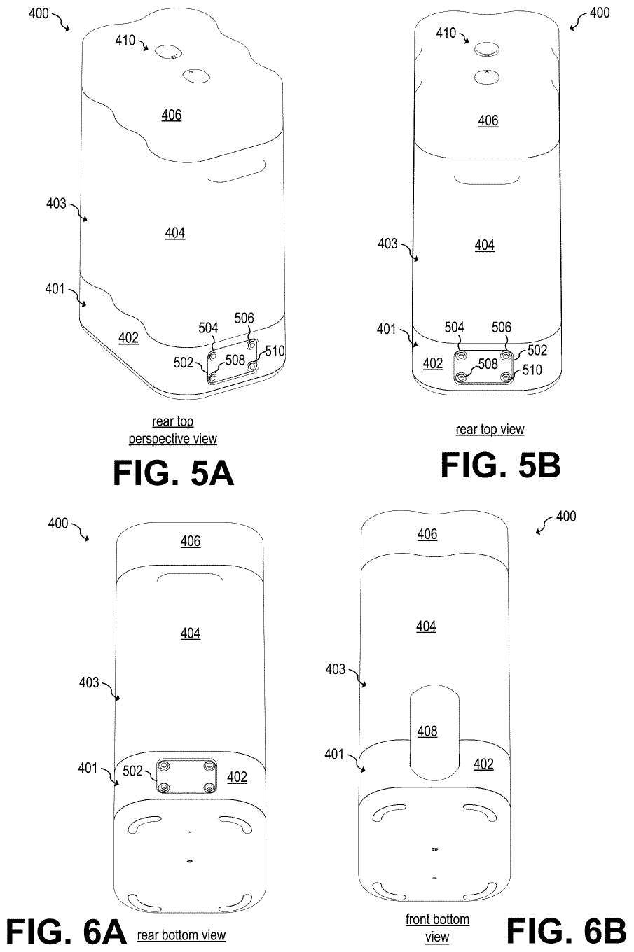

FIGS. 4A-6B shows various views of RO filtration system 400, according to an embodiment of the present invention. RO filtration system 400 includes base 402, magazine 404, and lid 406 (also referred to as cover 406).

For purposes of the description below, it is assumed that RO filtration system 400 is implemented as a 4-stage RO water filtration system including water filter stages 102, 104, 106, and 108, and water storage tank 202. However, it is understood that, in some embodiments, more than 4 stages of filtration (e.g., 5 or more), or less than 4 stages of filtration (e.g., 3 or less) may be used. In some embodiments, different types of filtration stages may be used. For example, some embodiments may not include the remineralization stage inside post-filter stage 108 and instead may include only a post-carbon filter. Some embodiments may not include post-filter stage 108. Some embodiments may not include an RO filtration stage. In some embodiments, the cartridge incorporating the carbon filter (e.g., 104) may include additional resins to remove additional dissolved solids. Other implementations are also possible.

In some embodiments, base 402 includes a panel that includes inlet manifold 502, e.g., for receiving input water, distributing water to/from a water storage tank (not shown), delivering drinking water to a faucet (not shown) and delivering wastewater to the drain. Base 402 also includes mechanical lever 408 for detaching base 402 from magazine 404. Base 402 also includes water tubing for directing the flow of water to/from the water filter stages (e.g., 102, 104, 106, 108). In some embodiments, base 402 also includes electronic circuits (not shown), sensors (not shown), e.g., for determining water quality, water flow, etc., and water valves (not shown).

In some embodiments, lever 408 may be implemented mechanically (e.g., as shown in FIGS. 4A-4C), where the lever 408 engages and causes magazine 404 to remain attached to base 402 when lever 408 is in a first position (e.g., vertical, as shown in FIGS. 4A-6B), and where lever disengages and causes magazine 404 to detached from base 402 when lever 408 is in a second position (e.g., horizontal, not shown in FIGS. 4A-4C). In some embodiments, the mechanism for keeping magazine 404 attached to base 402 and for detaching magazine 404 from base 402 may be implemented in other ways, such as by using an electronic switch and using a powered mechanism.

In some embodiments, base housing 401 covers sides, top, and bottom, of base 402, e.g., as shown in FIGS. 4A-6B.

In some embodiments, magazine 404 includes, inside magazine housing 403, receptacles (not shown), e.g., for receiving water filter stages 102, 104, 106, 108, and a battery receptacle (not shown) for receiving a battery, e.g., for powering the electronic circuits of base 402. In some embodiments, magazine 404 also includes one or more sensors (which may be powered by the battery, e.g., via base 402).

In some embodiments, magazine housing 403 covers sides, and bottom of magazine 404 and partially covers the top of magazine 404, e.g., as shown in FIGS. 4A-6B.

In some embodiments, lid 406 includes latching system 410 for detaching lid 406 from magazine 404, e.g., for allowing access to install/remove/replace water filters and/or a battery inside magazine 404.

As illustrated in FIGS. 4A-6B, in some embodiments, RO filtration system 400 fully encloses inside a housing (formed by housing 401 and 403 and lid 406) water filters, battery, electronic circuits, water tubing, sensors, a permeate pump, and water valves, which may advantageously result in less clutter (e.g., under the sink).

As can be seen in FIGS. 4A-6B, in some embodiments, magazine 404 may be detached from base 402, which may advantageously allow for moving magazine 404 to an area with more accessibility than under the sink (such as in the floor or in a kitchen countertop) for installing, removing, or replacing water filters and/or the battery.

In some embodiments, latching solenoid valves may be used to automatically stop the flow of input water from base 402 to magazine 404 upon actuation of lever 408, which may advantageously allow for the replacement of water filters and/or the battery without manually turning off the input water to RO filtration system 400.

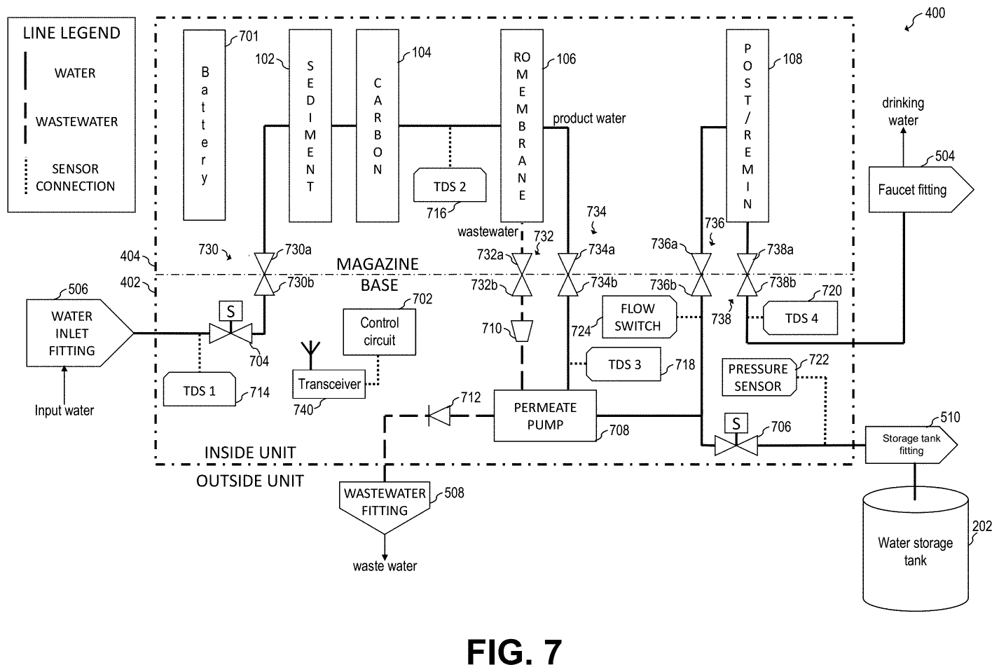

FIG. 7 shows a schematic diagram of RO filtration system 400, according to an embodiment of the present invention.

As shown in FIG. 7, in some embodiments, base 402 includes control circuit 702, latching solenoid valves 704 and 706, permeate pump 708, flow restrictor 710, check valve 712, total dissolved solids (TDS) sensors 714, 718 and 720, pressure sensor 722, flow switch 724, manifold 729b (which includes poppet valves mob, 732b, 734b, 736b, and 738b), and a transceiver 740. In some embodiments, the manifold 502 of base 402 includes water inlet fitting 506, wastewater fitting 508, faucet fitting 504 and storage tank fitting 510.

In some embodiments, including inside base 402 (e.g., inside housing 401) all of the control components (e.g., 702, 704, 706, 708, 738) and most or all sensors (e.g., 714, 718, 720, 722, 724) may advantageously result in a less complex solution from a manufacturing perspective. In some embodiments, having all of the control components (e.g., 702, 704, 706, 708, 738) inside base 402 (e.g., inside housing 401) advantageously avoids disconnecting one or more control component from each other when magazine 404 is detached from base 402.

As shown in FIG. 7, in some embodiments, magazine 404 includes filtration stages 102, 104, 106, and 108, battery 701, TDS sensor 716, and manifold 729a, which includes poppet valves 730a, 732a, 734a, 736a, and 738a. Filters stages 102, 104, 106, and 108, and battery 701 may be implemented as (e.g., removable) cartridges.

In some embodiments, manifold 729a, which couples to manifold 729b, distributes water from/to base 402 to/from magazine 404.

As also shown in FIG. 7, poppet valves 730a, 732a, 734a, 736a, and 738a and poppet valves 730b, 732b, 734b, 736b, and 738b form poppet valve pairs 730, 732, 734, 736, and 738, which advantageously prevent water leakage (from base 402 and from magazine 404) when magazine 404 is detached from base 402. Poppet valves 730a, 732a, 734a, 736a, 738a, 730b, 732b, 734b, 736b, and 738b, may be implemented in any way known in the art.

In some embodiments, water flows inside base 402 and inside magazine 404 through water tubes. For example, in some embodiments (and as illustrated in FIG. 7), water inlet fitting 506 is coupled to latching solenoid valve 704 via a water tube; TDS sensor 714 is coupled to poppet valve 730b via a water tube; poppet valve 730a is coupled to stage 102 via a water tube; stage 102 is coupled to stage 104 via a water tube; stage 104 is coupled to stage 106 via a water tube; stage 106 is coupled to poppet valves 732a and 734a using first and second water tubes, respectively; poppet valve 732b is coupled to flow restrictor 710 via a water tube; flow restrictor 710 is coupled to permeate pump 708 via a water tube; poppet valve 734b is coupled to permeate pump 708 via a water tube, permeate pump 708 is coupled to check valve 712 via a water tube; check valve 712 is coupled to wastewater fitting 508 via a water tube; permeate pump 708 is coupled to latching solenoid valve 706 via a water tube; latching solenoid valve 706 is coupled to storage tank fitting 510 via a water tube; latching solenoid valve 706 is coupled to poppet valve 736b via a water tube; poppet valve 736a is coupled to stage 108 via a water tube; stage 108 is coupled to poppet valve 738a via a water tube; and poppet valve 738b is coupled to faucet fitting 504 via a water tube. In some embodiments, water may be distributed inside base 402 and magazine 404 in other ways. For example, in some embodiments, water may be routed between components with a flow manifold. The flow manifold may be implemented with plastic and components (e.g., valves, flow switch, TDS sensors, etc.) may be installed into the flow manifold. The flow manifold may have internal channels that route the water between components. Thus, in some embodiments, the flow manifold may be used instead of water tubing.

In some embodiments, tubing may be used in conjunction with a flow manifold. For example, if a single (or a few) components are far away from the flow manifold, a tube may be used to connect such single (or few) components to the flow manifold. As another example, tubing may be used to connect the flow manifold to a permeate pump. Other implementations are also possible.

As can be seen in FIG. 7, the water flows into base 402 from water inlet fitting 506, then then to magazine 404 via latching solenoid valve 704 and poppet valve pair 730, and then through filtering stages 102, 104, and 106. Wastewater flows from stage 106 back to base 402 via poppet valve pair 732 into permeate pump 708 and product water (clean water) flows from stage 106 to permeate pump 708 via poppet valve pair 734. Permeate pump 708 delivers product water to water storage tank 202 via latching solenoid valve 706 with the aid of the wastewater, and delivers wastewater to the drain via check valve 712 and wastewater fitting 508. When the faucet is open, clean water flows from water storage tank 202 to base 402 (via storage tank fitting 510) and then to stage 108 (in magazine 404) via latching solenoid valve 706 and poppet valve pair 736. Stage 108 delivers drinking water back to base 402 via poppet valve pair 738, and base 402 delivers drinking water out (e.g., to the faucet) via faucet fitting 504.

TDS sensors 714, 716, 718, and 720 are configured to measure impurities in water (and thus provide a metric for water quality) of the respective water flow. For example, TDS sensor 714 is configured to detect impurities in the input water. TDS sensor 716 is configured to detect impurities in the water delivered by carbon filter 104. TDS sensor 718 is configured to detect impurities in the product water delivered by RO stage 106. TDS sensor 720 is configured to detect beneficial minerals and/or impurities in the drinking water (delivered by stage 108). TDS sensors 714, 716, 718, and 720 may be implemented in any way known in the art. For example, in some embodiments, TDS sensors 714, 716, 718, and 720 may include a water temperature calibration feature. Other implementations are also possible.

In some embodiments, TDS sensors may be used in other places, such as for monitoring the quality of the wastewater (the rejected water delivered by RO stage 106). In some embodiments, one or more (or all) TDS sensors 714, 716, 718, and 720 may be omitted. For example, in some embodiments in which stage 104 includes only a carbon filter (and no additional filtering media), TDS sensor 716 may be omitted.

In some embodiments, permeate pump 708 is configured to improve the water efficiency (the ratio between product water and wastewater) of RO stage 106 by using wastewater to create pressure to push product water into water storage tank 202 in a known manner. Permeate pump 708 may be implemented in any way known in the art.

In some embodiments, check valve 712 is configured to allow the flow of wastewater in one direction only (out through wastewater fitting 508). Check valve 712 may be implemented in any way known in the art.

In some embodiments, flow restrictor 710 is configured to restrict the flow of wastewater out of RO stage 106 to maintain high pressure inside the RO membrane of RO stage 106. Flow restrictor 710 may be implemented in any way known in the aft.

In some embodiments, latching solenoid valves 704 and 706 are configured to open to allow water to flow through them and to close to prevent the flow of water through them based on control signals (e.g., provided by control circuit 702). Latching solenoid valves 704 and 706 may be implemented in any way known in the art.

In some embodiments, flow switch 724 is configured to detect when water is flowing into stage 108. Flow switch 724 may be implemented in any way known in the art. For example, in some embodiments, flow switch 724 is a mechanical switch that completes a circuit when activated (e.g., when water is flowing) and which opens the circuit when water is not flowing. Thus, in some embodiments, flow switch 724 does not consume electrical power.

In some embodiments, stages 102, 104, 106, and 108 may be implemented in any way known in the art. In some embodiments, one or more of stages 102, 104, 106, and 108 may be omitted or replaced with a different type of stage. For example, in some embodiments, stage 108 may be omitted and drinking water may be delivered directly from water storage tank 202. In some embodiments, more than 4 stages may be used for the water filtration process. Other implementations are also possible.

In some embodiments, water storage tank 202 is configured to store filtered water (e.g., from RO stage 106) and deliver the filtered water (e.g., to stage 108) when the faucet is open. Water storage tank 202 may be implemented in any way known in the art.

In some embodiments, battery 701 is configured to provide power, e.g., directly or indirectly, to control circuit 702, latching solenoid valves 704 and 706, TDS sensors 714, 716, 718, and 720, and pressure sensor 722. Battery 701 may be implemented in any way known in the aft. For example, in some embodiments, battery 701 is non-rechargeable. In some embodiments, battery 701 is rechargeable (e.g., via wired or wireless charging). In some embodiments, battery 701 is fully sealed. In some embodiments, battery 701 is implemented as a battery pack with, e.g., 3 cells of alkaline batteries having, e.g., 1.5 V each (thus delivering 4.5 V and having an operational range between 3.6 V and 4.5 V). Other implementations are also possible.

In some embodiments, a coulomb counter (not shown) may be used to estimate the amount of charge remaining in battery 701. In some embodiments, the voltage delivered by battery 701 is used as an indication of the amount of charge remaining in battery 701.

In some embodiments, control circuit 702 is configured to control latching solenoid valves 704 and 706, receive information from TDS sensors 714, 716, 718, and 720, flow switch 724, and pressure sensor 722, and provide information to a user (e.g., an external device, such as a mobile device or a remote server). In some embodiments, control circuit 702 may be implemented in a printed circuit board (PCB) and may include a general purpose or custom microcontroller or processor coupled to a memory and configured to execute instructions stored in the memory.

In some embodiments, control circuit 702 is coupled to communicate with transceiver 740. Transceiver 740 can be used to communicate information to and/or from the filtration system. For example, transceiver 740 can communicate wirelessly with a WiFi or other network to share information with a remote server (via the Internet) or user equipment (e.g., a smart phone). Alternatively, or in addition, the transceiver may communicate directly with the Internet. Embodiments also envision transceiver 740 communicating with the UE via Bluetooth, as another example. In other embodiments, transceiver 740 can be hardwired to a network. Methods utilizing this capability will be discussed in more detail below. In some embodiments, pressure sensor 722 is configured to sense the pressure of water storage tank 202. In some embodiments, pressure sensor 722 is configured to detect the water pressure in water storage tank 202, and when the water pressure reaches a set value e.g., 45 psi, latching solenoid valve 704 is configured to close to stop water flow from water inlet fitting 506, Pressure sensor 722 may be implemented in any way known in the art.

In some embodiments, pressure sensor 722 may be used to estimate the amount (e.g., volume) of water in water storage tank 202. For example, in some embodiments, a relationship between volume of water stored in water storage tank 202 and pressure of water storage tank 202 may be established (e.g., empirically). For example, in some embodiments, a plurality (e.g., 30) of water storage tanks (e.g., of a same model) may be characterized so as to empirically identify for each tank a relationship between total volume of water stored and pressure. A polynomial fit may be use to determine an equation approximating, e.g., the mean relationship (pressure versus volume of water) across the plurality of tanks. Such determined relationship (e.g., expressed as an equation) may be used to determine the volume of water stored at a particular water storage tank 202 at any given time.

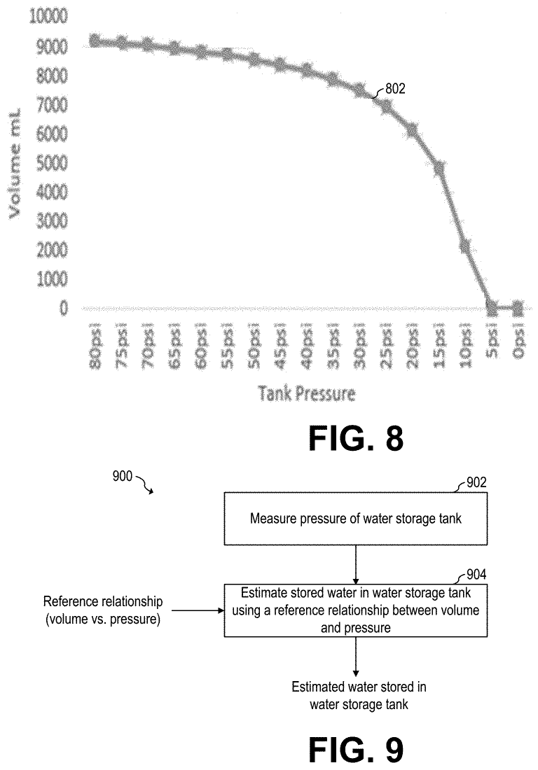

FIG. 8 shows total volume of water versus pressure of a particular water storage tank 202, according to an embodiment of the present invention. Curve 802 shows the empirically determined mean relationship between total volume of water stored at a water storage tank versus pressure.

In some embodiments, the relationship between volume of water stored in water storage tank 202 and pressure may be based on the input water pressure (e.g., received at water inlet fitting 506). For example, in some embodiments, when water storage tank 202 is full, the pressure of water storage tank 202 is equal the input water pressure, which may vary from installation to installation. For example, in a first setup, the input water pressure may be 40 psi and the pressure associated with a full tank may be 40 psi. In a second setup, the input water pressure may be 80 psi and the pressure associated with a full tank may be 80 psi.

In some embodiments, an initialization process is performed during installation of RO filtration system 400 to calibrate (e.g., normalize) the relationship between volume of water stored in water storage tank 202 and pressure. For example, in some embodiments, after the installation of RO filtration system 400 (e.g., under the sink) is complete and water storage tank 202 is full of water, pressure sensor 722 measures the pressure of water storage tank and stores such measured pressure in non-volatile memory (not shown) of control circuit 702. A calibrated relationship between volume of water stored in water storage tank 202 and pressure is generated by scaling the reference relationship (e.g., as shown in FIG. 8) such that the maximum water volume corresponds to the measured pressure stored in the non-volatile memory.

FIG. 9 shows a flow chart of embodiment method 900 for estimating the water stored in water storage tank 202, according to an embodiment of the present invention. Method 900 may be performed, e.g., by control circuit 702.

During step 902, a pressure sensor (such as pressure sensor 722) is used to measure the pressure of water storage tank 202. In some embodiments, step 902 is performed when no water is flowing out of faucet fitting 504. For example, in some embodiments, step 902 is performed when flow switch 724 indicates that no water is flowing.

During step 904, the volume of water stored in water storage tank 202 is determined based on the pressure measured during step 902 and on a (e.g., calibrated) reference relationship between volume and pressure of the water storage tank (e.g., as shown in FIG. 8). In some embodiments, the reference relationship is stored in the form of an Equation or look-up table (LUT) in a non-volatile memory (e.g., of or coupled to control circuit 702).

In some embodiments, pressure sensor 722 may be used to estimate how much water has passed through RO filtration system 400. For example, in some embodiments, the volume of water dispensed each time the faucet is open may be determined by measuring the amount of water in the tank before the faucet is open and after the faucet is closed (e.g., using method 900). For example, the volume of water dispensed Wdis may be given by

W_{dis}=W_{b}−Wₐ (1)

where W_{b} represents the volume of water stored in water storage tank 202 before the faucet is open and Wₐ represents the volume of water stored in water storage tank 202 after the faucet is closed. W_{b} and Wₐ may be determined using method 900 before (simultaneously or immediately after) the faucet is open, and (e.g., immediately) after or simultaneously with the closing of the faucet, respectively.

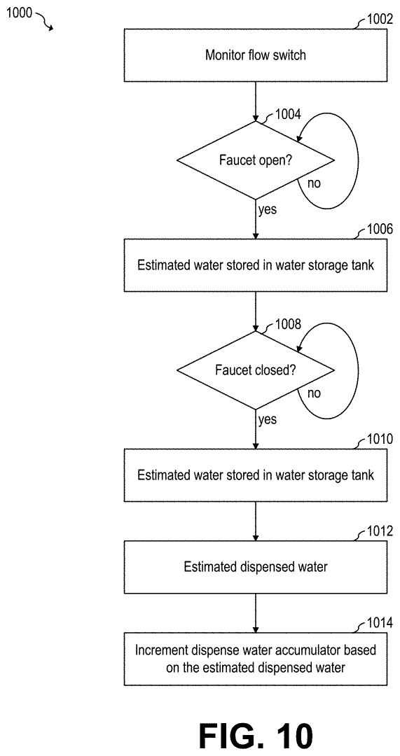

FIG. 10 shows a flow chart of embodiment method for determining the volume of water flowing through RO filtration system 400, according to an embodiment of the present invention. Method 1000 may be performed, e.g., by control circuit 702.

During step 1002, a flow switch (e.g., 724) indicative of water flowing through the faucet (e.g., via faucet fitting 504) is monitored.

As shown by step 1004, when the flow switch indicates that the faucet is open, the water stored in the water storage tank (e.g., 202) is determined during step 1006 (e.g., using method 900).

As shown by step 1008, after performing step 1006, when the flow switch indicates that the faucet is closed, the water stored in the water storage tank is determined during step 1010 (e.g., using method 900).

During step 1012, the total volume of dispensed water while the faucet was open is determined, e.g., using Equation 1.

During step 1014, an accumulator (not shown), such as a digital accumulator (e.g., implemented by control circuit 702) is incremented by the estimated volume of water dispensed determined during step 1012. Thus, in some embodiments, the value stored in the accumulator is indicative of the total volume of water that has flowed through RO filtration system 400.

In some embodiments, pressure sensor 722 may be used to detect water leakage in RO filtration system 400. For example, in some embodiments, pressure sensor 722 may monitor the pressure of water storage tank 202 while the faucet is closed. During normal operation (no leakage present), no drop in tank pressure should occur when the faucet is closed. A drop in tank pressure when the faucet is closed is indicative of a water leakage and can be detected by monitoring a tank pressure drop when the faucet is closed. For example, Figure n shows a flow chart of embodiment method 1100 for detecting water leakage in RO filtration system 400, according to an embodiment of the present invention. Method 1100 may be performed, e.g., by control circuit 702.

During step 1102, a pressure sensor (e.g., 722) is used to measure the pressure of a water storage tank (e.g., 202) when the faucet is closed.

Simultaneously or immediately after performing step 1102, a timer (e.g., implemented by control circuit 702) is started. In some embodiments, the timer is set with a period of minutes, such as 1 minute, 10 minutes, 30 minutes, an hour, or more. As shown by steps 1106, 1108, and 1110, if the faucet is open to dispense water before the timer has expired, step 1102 is performed again after the faucet is closed.

During step 1112, once the timer expires (when the programmed time has elapsed), the pressure sensor measures the tank pressure of the water storage tank. If it is determined during step 1114 that the tank pressure dropped, water leakage is detected.

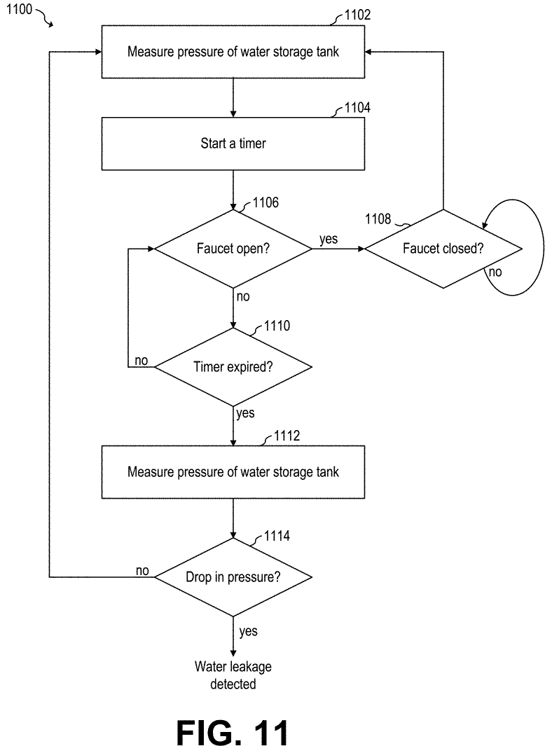

As shown in FIG. 11, method 1100 may be performed continuously by periodically monitoring the tank pressure of water storage tank 202 to determine if a water leakage exists.

As shown in FIG. 11, leakage detection may be performed based on the comparison (step 1114) of tank pressures measured during steps 1102 and 1112. In some embodiments, method 1100 may be modified to compare (e.g., during step 1114) the estimated water stored in water storage tank (e.g., determined during steps 1102 and 1112 using, e.g., method 900), where a detecting is detected when the water stored in the water storage tank drops.

In some embodiments, pressure sensor 722 may be used to monitor the health of water storage tank 202. For example, in some embodiments, a drop in the rate of pressure change while the faucet is open may be indicative of a faulty water storage tank. For example, in some embodiments, a drop in the rate of pressure change while the faucet is open may be indicative of a water storage tank that is low on air and that should be repressurized or replaced.

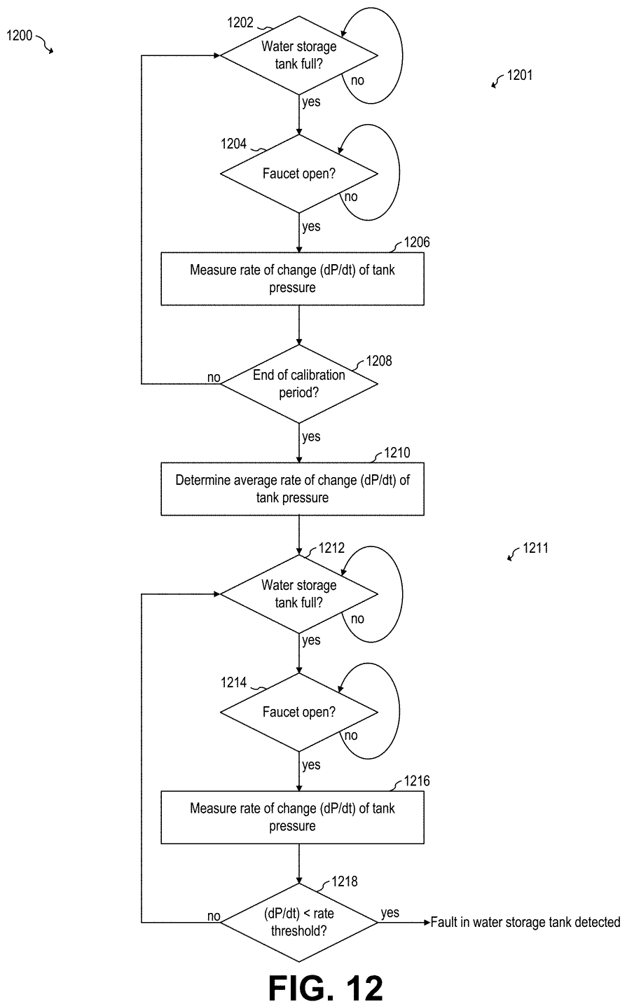

FIG. 12 shows a flow chart of embodiment method 1200 for monitoring the health of water storage tank 202, according to an embodiment of the present invention. Method 1200 may be performed, e.g., by control circuit 702.

As shown in FIG. 12, method 1200 includes calibration phase 1201 and testing phase 1211. Calibration phase 1201 includes steps 1202, 1204, 1206, 1208, and 1210. Testing phase 121 includes steps 1212, 1214, 1216, and 1218.

During step 1202, it is determined whether water storage tank 202 is full. For example, in some embodiments, such determination may be performed by comparing the tank pressure (e.g., as measured by pressure sensor 722) with the input water pressure (e.g., when the tank pressure matches the input water pressure, water storage tank 202 is full). In some embodiments, the water storage tank 202 is determined to be full when the tank pressure stops increasing.

As illustrated by steps 1204 and 1206, the rate of change of the tank pressure over time is measured during step 1206 as soon as the faucet is open. For example, in some embodiments, the tank pressure is measured at times t₁ and t₂ after the faucet is open, the rate of change of tank pressure dP/dt may be given by

$$\frac{dP}{dt} = \frac{{P}_{2} - {P}_{1}}{{t}_{2} - {t}_{1}} = \frac{Δ P}{Δ t} \qquad ( 2 )$$

where P₁ and P₂ represents the tank pressure (e.g., measured by pressure sensor 722) at times t₁ and t₂, respectively. In some embodiments, t₁ occurs immediately after the faucet is open (e.g., as determined by flow switch 724). In some embodiments, t₂ occurs 5 seconds after t₁. In some embodiments, times t₁ and t₂ may occur at other times.

If it is determined that the calibration period has not ended during step 1208, steps 1202, 1204 and 1206 are repeated. In some embodiments, the calibration period is equal to a few days (e.g., 5 days, 7 days, or more), a few weeks (e.g., 2 weeks, 3 weeks, or more), or a month, for example. In some the calibration period may last longer than 1 month, such as 1.5 months, 2 months, or more.

After the calibration period ends, the average rate of change of tank pressure is determined during step 1210.

Steps 1212, 1214, and 1216 may be performed in a similar manner as steps 1202, 1204, and 1206.

During step 1218, the rate of change of tank pressure determined during step 1216 is compared with a rate threshold, where the rate threshold may be based on the average rate of change of tank pressure determined during step 1210. For example, in some embodiments, the rate threshold may be, e.g., 80% of the average rate of change of tank pressure determined during step 1210. Other values may be used.

If the rate of change of tank pressure is below the rate threshold, a fault in the water storage tank is detected.

In some embodiments, control circuit 702 may alert a user that one or more components of RO filtration system 400 should be replaced based on outputs of one or more sensors (e.g., 714, 716, 718, 720, and 722). In some embodiments, control circuit 702 and/or a remote server may cause the shipment of such components based on outputs of one or more sensors (e.g., 714, 716, 718, 720, and 722). In some embodiments, transceiver 740, coupled to the control circuit, may transmit a notification related to degradation of one or more components of RO filtration system 400. In some embodiments, the transceiver 740 may communicate with a remote server to initiate replacements for the components.

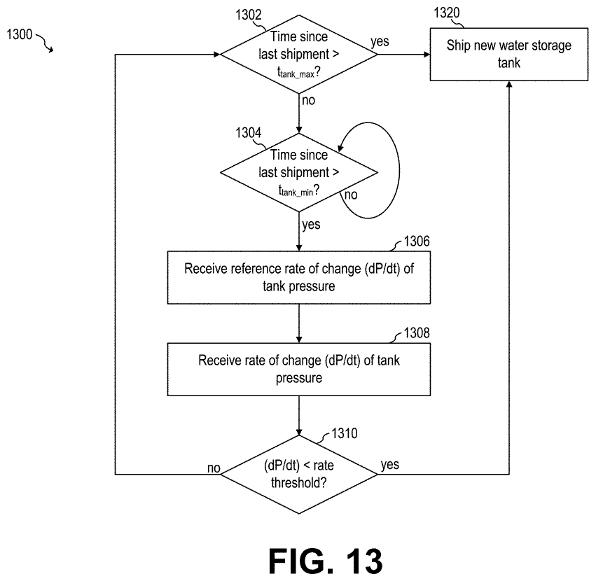

FIGS. 13-17 illustrate methods for the automatic shipment of replacement components of RO filtration system 400, according to embodiments of the present invention. In some embodiments, one or more methods 1300, 1400, 1500, 1600, and 1700 may be performed in concurrently. For example, in some embodiments a remote server obtaining information from control circuit 702 (e.g., via the Internet using transceiver 740) about the state of RO filtration system 400 may perform one or more of methods 1300, 1400, 1500, 1600, and 1700 and may determine that one or more components (e.g., cartridges and/or a water tank) should be replaced and such one or more replacement components may be shipped simultaneously.

FIG. 13 shows a flow chart of embodiment method 1300 for automatic shipment of a replacement water storage tank 202, according to an embodiment of the present invention. In some embodiments, method 1300 may be implemented by control circuit 702 in cooperation with a remote server (not shown). In some embodiments, method 1300 may be implemented entirely by a remote server (e.g., receiving data from control circuit 702, e.g., via the Internet using transceiver 740).

During step 1302, it is determined whether the last shipment and/or last change event of a water storage tank 202 (or the time of installation of RO filtration system 400) is greater than a predetermined threshold t_{tank_max}. If the output of step 1302 is “yes,” a new water storage tank 202 is shipped during step 1320, e.g., to the address where RO filtration system 400 is installed. If the output of step 1302 is “no,” step 1304 is performed.

In some embodiments, the predetermined threshold t_{tank_max} may be, e.g., 60 months. In some embodiments, the predetermined threshold t_{tank_max} may be higher than 60 months (e.g., 65 months, 72 months, or higher) or lower than 60 months (e.g., 55 months, 48 months, or lower).

During step 1304, it is determined whether the last shipment or change event of a water storage tank 202 (or the time of installation of RO filtration system 400) is greater than a predetermined threshold t_{tank_min}. If the output of step 1304 is “no,” then a new water storage tank 202 has been recently shipped and/or has been recently installed. Thus, in some embodiments, if the output of step 1304 is “no,” steps 1304 may be performed periodically until the output of step 1304 becomes “yes.” If the output of step 1304 is “yes,” step 1306 is performed.

In some embodiments, performing step 1304 prevents the automatic shipment of multiple water storage tanks within a short period of time

In some embodiments, the predetermined threshold t_{tank_min} may be, e.g., 12 months In some embodiments, the predetermined threshold t_{tank_min} may be higher than 12 months (e.g., 13 months, 18 months, or higher) or lower than 12 months (e.g., 10 months, 6 months, or lower).

During step 1306, a reference rate of change of the tank pressure of water storage tank 202 is received. In some embodiments, the reference rate of change may be determined by method 1200.

During step 1308, a current rate of change of the tank pressure of water storage tank 202 is received. In some embodiments, the current rate of change of the tank pressure may be obtained by performing steps 1212, 1214, and 1216.

During step 1310, the current rate of change of tank pressure (determined during step 1308) is compared with a rate threshold, where the rate threshold may be based on the reference rate of change of tank pressure received during step 1306. For example, in some embodiments, the rate threshold may be, e.g., 80% of the reference rate of change of tank pressure received during step 1306. Other values may be used.

If the output of step 1310 is “yes,” step 1320 is performed.

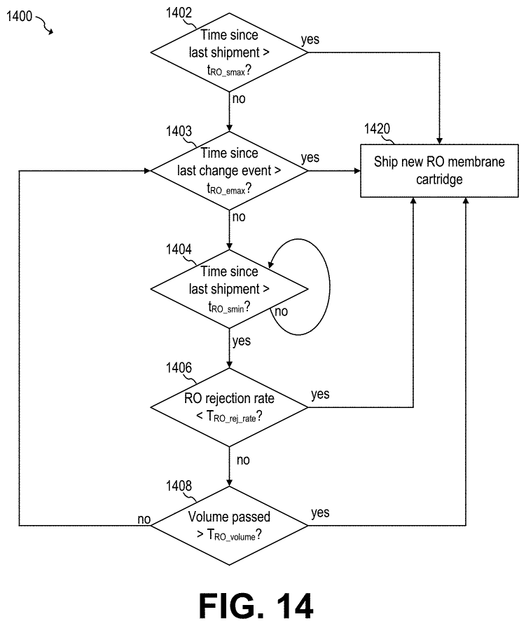

FIG. 14 shows a flow chart of embodiment method 1400 for automatic shipment of an RO membrane cartridges 106, according to an embodiment of the present invention. In some embodiments, method 1400 may be implemented by control circuit 702 in cooperation with a remote server (not shown). In some embodiments, method 1400 may be implemented entirely by a remote server (e.g., receiving data from control circuit 702, e.g., via the Internet using transceiver 740).

During step 1402, it is determined whether the last shipment of an RO membrane cartridge 106 (or the time of installation of RO filtration system 400) is greater than a predetermined threshold t_{RO_smax}. If the output of step 1402 is “yes,” a new RO membrane cartridge 106 is shipped during step 1420, e.g., to the address where RO filtration system 400 is installed. If the output of step 1402 is “no,” step 1403 is performed.

In some embodiments, the predetermined threshold t_{RO_smax} may be, e.g., 18 months. In some embodiments, the predetermined threshold t_{RO_smax} may be higher than 18 months (e.g., 20 months, 24 months, or higher) or lower than 18 months (e.g., 16 months, 12 months, or lower).

During step 1403, it is determined whether the last change event of an RO membrane cartridge 106 (or the time of installation of RO filtration system 400) is greater than a predetermined threshold t_{RO_smax}. If the output of step 1403 is “yes,” step 1420 is performed. If the output of step 1403 is “no,” step 1404 is performed.

In some embodiments, the predetermined threshold t_{RO_emax} may be, e.g., 18 months. In some embodiments, the predetermined threshold t_{RO_emax} may be higher than 18 months (e.g., 20 months, 24 months, or higher) or lower than 18 months (e.g., 16 months, 12 months, or lower). In some embodiments, t_{RO_emax} may be equal to t_{RO_smax}. In some embodiments, t_{RO_emax} may be different (e.g., lower or higher) than t_{RO_smax}. For example, in some embodiments, t_{RO_emax} may be 16 month and t_{RO_smax} may be 18 months.

During step 1404, it is determined whether the last shipment of a RO membrane cartridge 106 (or the time of installation of RO filtration system 400) is greater than a predetermined threshold t_{RO_min}. If the output of step 1404 is “no,” then a new RO membrane cartridge 106 has been recently shipped and/or has been recently installed. Thus, in some embodiments, if the output of step 1404 is “no,” steps 1404 may be performed periodically until the output of step 1404 becomes “yes.” If the output of step 1404 is “yes,” step 1406 is performed.

In some embodiments, performing step 1404 prevents the automatic shipment of multiple RO membrane cartridges within a short period of time

In some embodiments, the predetermined threshold t_{RO_min} may be, e.g., 6 months. In some embodiments, the predetermined threshold t_{RO_min} may be higher than 6 months (e.g., 7 months, 8 months, or higher) or lower than 6 months (e.g., 5 months, 4 months, or lower).

During step 1406, the rejection rate of stage 106 is determined and compared with a predetermined rejection threshold T_{RO_rej_rate}. If the output of step 1406 is “yes,” step 1420 is performed.

In some embodiments, the rejection rate of stage 106 may be determined using the outputs of a TDS sensor measuring the water quality at the input of stage 106 (e.g., TDS sensors 714 or 716) and the output of a TDS sensor measuring the water quality at the output of stage 106 (e.g., TDS sensor 718 or 720). For example, in some embodiments, the rejection rate of a filtering stage or group of stages may be given by

$${R}_{rej} = 1 - \frac{{Out}_{tdsppm}}{{In}_{tdsppm}} \qquad ( 3 )$$

where OUT_{tdsppm} represents the TDS ppm at the output of the stage to be measured (e.g., as measured by a first TDS sensor) and IN_{tdsppm} represents the TDS ppm at the input of the stage to be measured (e.g., as measured by a first TDS sensor).

In some embodiments, the predetermined rejection threshold T_{RO_rej_rate} may be, e.g., 90%. In some embodiments, the predetermined rejection threshold T_{RO_rej_rate} may be higher than 90% (e.g., 91%, 95%, or higher) or lower than 90% (e.g., 85%, 80%, or lower).

In some embodiments, step 1406 compares the average of the rejection rates over the last n days with the predetermined rejection threshold T_{RO_rej_rate}. In some embodiments, n is equal to 7 days. Values higher than 7 days (e.g., 10 days, 14 days, or higher) or lower than 7 days (e.g., 6 days, 4 days, or lower) may also be used.

During step 1408, the volume of water that has passed through stage 106 since stage 106 was installed is compared with a predetermined volume threshold T_{RO_volume}. If the output of step 1408 is “yes,” step 1420 is performed.

In some embodiments, the volume of water that has passed through stage 106 since stage 106 was installed may be determined using method 1000 (e.g., using a dedicated accumulator to track volume of water since stage 106 was installed).

In some embodiments, predetermined volume threshold T_{RO_volume} may be, e.g., 1500 gallons. Other values, (e.g., higher than 1500 gallons, such as 1600 gallons or higher, or lower than 1500 gallons, such as 1400 gallons or lower) may also be used.

In some embodiments, thresholds t_{RO_emax} and/or t_{RO_smax} may be dynamically determined based on the time it has taken in the past for RO filtration system 400 to reach α*T_{RO_volume}, where α is equal to 100%, 110%, or more. For example, in some embodiments, t_{RO_emax} may be the maximum (or minimum, or average) value between a percentage (e.g., 80%, 90%, 100%, 110% or higher) of the time it has taken (e.g., the last time) for RO filtration system 400 to reach α*T_{RO_volume} and a predetermined threshold (e.g., 18 month).

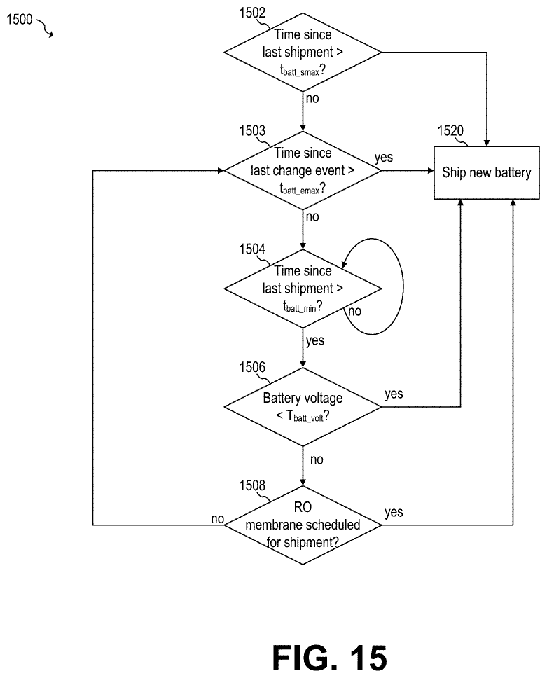

FIG. 15 shows a flow chart of embodiment method 1500 for automatic shipment of a replacement battery 701, according to an embodiment of the present invention. In some embodiments, method 1500 may be implemented by control circuit 702 in cooperation with a remote server (not shown). In some embodiments, method 1500 may be implemented entirely by a remote server (e.g., receiving data from control circuit 702, e.g., via the Internet using transceiver 740).

During step 1502, it is determined whether the last shipment of a battery cartridge 701 (or the time of installation of RO filtration system 400) is greater than a predetermined threshold t_{batt_smax}. If the output of step 1502 is “yes,” a new battery 701 is shipped during step 1520, e.g., to the address where RO filtration system 400 is installed. If the output of step 1502 is “no,” step 1503 is performed.

In some embodiments, the predetermined threshold t_{batt_smax} may be, e.g., 9 months. In some embodiments, the predetermined threshold t_{batt_smax} may be higher than 9 months (e.g., 20 months, 35 months, or higher) or lower than 9 months (e.g., 8 months, 7 months, or lower).

During step 1503, it is determined whether the last change event of a battery cartridge 701 (or the time of installation of RO filtration system 400) is greater than a predetermined threshold t_{batt_emax}. If the output of step 1503 is “yes,” step 1520 is performed. If the output of step 1503 is “no,” step 1504 is performed.

In some embodiments, the predetermined threshold t_{batt_emax} may be, e.g., 9 months. In some embodiments, the predetermined threshold t_{batt_emax} may be higher than 9 months (e.g., 20 months, 35 months, or higher) or lower than 9 months (e.g., 8 months, 7 months, or lower). In some embodiments, t_{batt_emax} may be equal to t_{batt_smax}. In some embodiments, t_{batt_emax} may be different (e.g., lower or higher) than t_{batt_smax}. For example, in some embodiments, t_{batt_emax} may be 35 month and t_{batt_smax} may be 9 months.

During step 1504, it is determined whether the last shipment of a battery cartridge 701 (or the time of installation of RO filtration system 400) is greater than a predetermined threshold t_{batt_min}. If the output of step 1504 is “no,” then a new battery cartridge 701 has been recently shipped and/or has been recently installed. Thus, in some embodiments, if the output of step 1504 is “no,” steps 1404 may be performed periodically until the output of step 1504 becomes “yes.” If the output of step 1504 is “yes,” step 1506 is performed.

In some embodiments, performing step 1504 prevents the automatic shipment of multiple battery cartridges within a short period of time

In some embodiments, the predetermined threshold t_{batt_min} may be, e.g., 30 days. In some embodiments, the predetermined threshold t_{batt_min} may be higher than 30 days (e.g., 35 days, 40 days, or higher) or lower than 30 days (e.g., 25 days, 15 days, or lower).

During step 1506, the battery voltage is determined and compared with a predetermined voltage threshold T_{batt_volt}. If the output of step 1506 is “yes,” step 1520 is performed.

In some embodiments, the battery voltage may be determined by measuring the voltage at the output of battery 701 (e.g., using an ADC). Other methods for measuring the voltage of battery 701 may also be used.

In some embodiments, the predetermined battery threshold T_{batt_volt} may be, e.g., a fixed voltage such as 1 V or a percentage of the nominal voltage of the battery (e.g., 15% of the nominal voltage of the battery when fully charged, such as 15% of 4.5 V). Other values may also be used.

During step 1508, it is determined whether an RO membrane has been shipped or scheduled for shipping during the past q days, where q may be, e.g., 2 days (values higher than 2 day such as 3 days, or higher, or lower than 2 days, such as 1 day, or lower, may also be used). If the output of step 1508 is “yes,” step 1520 is performed.

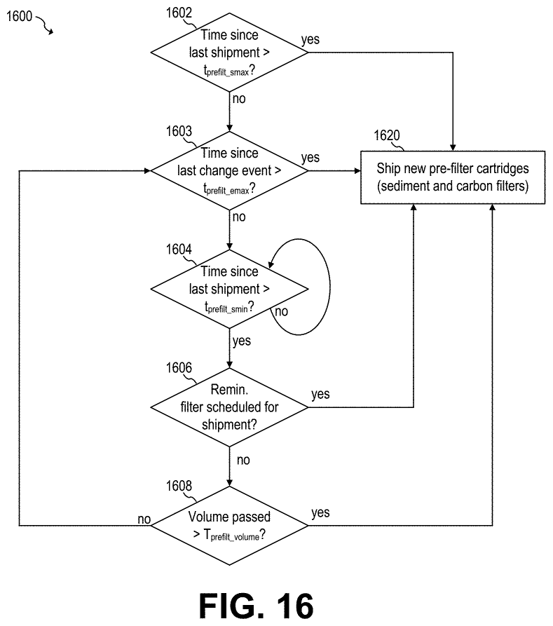

FIG. 16 shows a flow chart of embodiment method 1600 for automatic shipment of pre-filter cartridges 102 and 104, according to an embodiment of the present invention. In some embodiments, method 1600 may be implemented by control circuit 702 in cooperation with a remote server (not shown). In some embodiments, method 1600 may be implemented entirely by a remote server (e.g., receiving data from control circuit 702, e.g., via the Internet using transceiver 740).

During step 1602, it is determined whether the last shipment of pre-filter cartridges 102 and 104 (or the time of installation of RO filtration system 400) is greater than a predetermined threshold t_{profilt_smax}. If the output of step 1602 is “yes,” a new sediment filtration cartridge 102 and carbon filtration cartridge 104 are shipped during step 1620, e.g., to the address where RO filtration system 400 is installed. If the output of step 1602 is “no,” step 1603 is performed.

In some embodiments, the predetermined threshold t_{prefilt_smax} may be, e.g., 9 months. In some embodiments, the predetermined threshold t_{RO_smax} may be higher than 9 months (e.g., 10 months, 12 months, or higher) or lower than 9 months (e.g., 8 months, 7 months, or lower).

During step 1603, it is determined whether the last change event of pre-filter cartridges 102 and 104 (or the time of installation of RO filtration system 400) is greater than a predetermined threshold t_{prefilt_emax}. If the output of step 1603 is “yes,” step 1620 is performed. If the output of step 1603 is “no,” step 1604 is performed.

In some embodiments, the predetermined threshold t_{prefilt_emax} may be, e.g., 9 months. In some embodiments, the predetermined threshold t_{RO_emax} may be higher than 9 months (e.g., 10 months, 12 months, or higher) or lower than 9 months (e.g., 8 months, 7 months, or lower). In some embodiments, t_{prefilt_emax} may be equal to t_{prefilt_smax}. In some embodiments, t_{prefilt_emax} may be different (e.g., lower or higher) than t_{prefilt_smax}. For example, in some embodiments, t_{prefilt_emax} may be 8 month and t_{prefilt_smax} may be 9 months.

During step 1604, it is determined whether the last shipment of pre-filter cartridges 102 and 104 (or the time of installation of RO filtration system 400) is greater than a predetermined threshold t_{prefilt_min}. If the output of step 1604 is “no,” then new pre-filter cartridges 102 and 104 have been recently shipped and/or has been recently installed. Thus, in some embodiments, if the output of step 1604 is “no,” steps 1604 may be performed periodically until the output of step 1604 becomes “yes.” If the output of step 1604 is “yes,” step 1606 is performed.

In some embodiments, performing step 1604 prevents the automatic shipment of multiple pre-filter cartridges within a short period of time

In some embodiments, the predetermined threshold t_{prefilt_min} may be, e.g., 3 months. In some embodiments, the predetermined threshold t_{prefilt_min} may be higher than 3 months (e.g., 4 months, 5 months, or higher) or lower than 3 months (e.g., 2 months, 1 months, or lower).

During step 1606, it is determined whether a post-filter cartridge 108 has been shipped or scheduled for shipping during the past q days, where q may be, e.g., 2 days (values higher than 2 day such as 3 days, or higher, or lower than 2 days, such as 1 day, or lower, may also be used). If the output of step 1606 is “yes,” step 1620 is performed.

During step 1608, the volume of water that has passed through stage 108 since stage 108 was installed is compared with a predetermined volume threshold T_{prefilt_volume}. If the output of step 1608 is “yes,” step 1620 is performed.

In some embodiments, the volume of water that has passed through stage 108 since stage 108 was installed may be determined using method 1000 (e.g., using a dedicated accumulator to track volume of water since stage 108 was installed).

In some embodiments, predetermined volume threshold T_{prefilt_volume} may be, e.g., 800 gallons. Other values, (e.g., higher than 800 gallons, such as 900 gallons or higher, or lower than 800 gallons, such as 700 gallons or lower) may also be used.

In some embodiments, threshold t_{prefilt_emax} may be dynamically determined based on the time it has taken in the past for RO filtration system 400 to reach T_{prefilt_volume}. For example, in some embodiments, t_{prefilt_emax} may be the maximum value between a percentage (e.g., 100%, 110% or higher) of the time it has taken (e.g., the last time) for RO filtration system 400 to reach T_{prefilt_volume} and a predetermined threshold (e.g., 16 month).

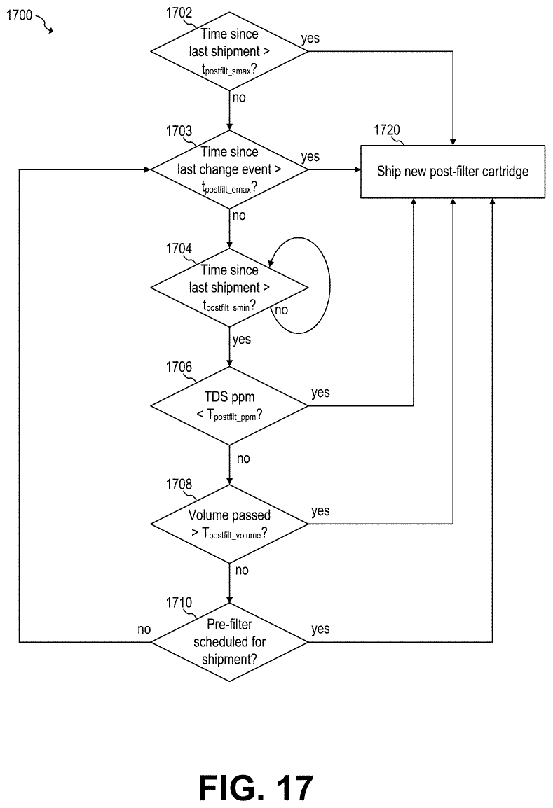

FIG. 17 shows a flow chart of embodiment method 1700 for automatic shipment of a post-filter cartridges 108, according to an embodiment of the present invention. In some embodiments, method 1700 may be implemented by control circuit 702 in cooperation with a remote server (not shown). In some embodiments, method 1700 may be implemented entirely by a remote server (e.g., receiving data from control circuit 702, e.g., via the Internet using transceiver 740).

During step 1702, it is determined whether the last shipment of a post-filter cartridge 108 (or the time of installation of RO filtration system 400) is greater than a predetermined threshold t_{postfilt_smax}. If the output of step 1702 is “yes,” a new a post-filter cartridge 108 is shipped during step 1720, e.g., to the address where RO filtration system 400 is installed. If the output of step 1702 is “no,” step 1703 is performed.

In some embodiments, the predetermined threshold t_{postfilt_smax} may be, e.g., 9 months. In some embodiments, the predetermined threshold t_{postfilt_smax} may be higher than 9 months (e.g., 10 months, 12 months, or higher) or lower than 9 months (e.g., 8 months, 7 months, or lower).

During step 1703, it is determined whether the last change event of a post-filter cartridge 108 (or the time of installation of RO filtration system 400) is greater than a predetermined threshold t_{postfilt_emax}. If the output of step 1703 is “yes,” step 1720 is performed. If the output of step 1703 is “no,” step 1704 is performed.

In some embodiments, the predetermined threshold t_{postfilt_emax} may be, e.g., 8 months. In some embodiments, the predetermined threshold t_{postfilt_emax} may be higher than 8 months (e.g., 10 months, 12 months, or higher) or lower than 8 months (e.g., 7 months, 6 months, or lower). In some embodiments, t_{postfilt_emax} may be equal to t_{postfilt_smax}. In some embodiments, t_{postfilt_emax} may be different (e.g., lower or higher) than t_{postfilt_smax}. For example, in some embodiments, t_{postfilt_emax} may be 8 month and t_{postfilt_smax} may be 9 months.

During step 1704, it is determined whether the last shipment of a post-filter cartridge 108 (or the time of installation of RO filtration system 400) is greater than a predetermined threshold t_{postfilt_min}. If the output of step 1704 is “no,” then a new post-filter cartridge 108 has been recently shipped and/or has been recently installed. Thus, in some embodiments, if the output of step 1704 is “no,” steps 1704 may be performed periodically until the output of step 1704 becomes “yes.” If the output of step 1704 is “yes,” step 1706 is performed.

In some embodiments, performing step 1704 prevents the automatic shipment of multiple post-filter cartridges within a short period of time

In some embodiments, the predetermined threshold t_{postfilt_min} may be, e.g., 3 months. In some embodiments, the predetermined threshold t_{postfilt_min} may be higher than 3 months (e.g., 4 months, 5 months, or higher) or lower than 3 months (e.g., 2 months, 1 months, or lower).

Step 1706 may be performed in embodiments implementing a remineralization media as part of post-filter cartridge 108 (in embodiments that do not implement a remineralization media as part of post-filter cartridge 108, step 1706 may be omitted).

During step 1706, the output of TDS sensor 720 is determined and compared with a predetermined TDS threshold T_{postfilt_ppm}. If the output of step 1706 is “yes,” step 1720 is performed (e.g., since the remineralization media is not adding back enough minerals to the drinking water and may thus be degraded or defective).

In some embodiments, TDS threshold T_{postfilt_ppm} may be a predefined fixed value, such s 45 ppm (higher or lower values may also be used). In some embodiments, TDS threshold T_{postfilt_ppm} may be a predefined fixed value above the TDS ppm at the input of stage 106. For example, if the output TDS sensor 718 is 30 TDS ppm and the predefined value is 45 TDS ppm, then step 1706 outputs yes if the output of TDS sensor 720 is lower than 75 TDS ppm.

During step 1708, the volume of water that has passed through stage 108 since stage 108 was installed is compared with a predetermined volume threshold T_{postfilt_volume}. If the output of step 1708 is “yes,” step 1720 is performed.

In some embodiments, the volume of water that has passed through stage 108 since stage 108 was installed may be determined using method 1000 (e.g., using a dedicated accumulator to track volume of water since stage 108 was installed).

In some embodiments, predetermined volume threshold T_{postfilt_volume} may be, e.g., 800 gallons. Other values, (e.g., higher than 800 gallons, such as 900 gallons or higher, or lower than 800 gallons, such as 700 gallons or lower) may also be used.

In some embodiments, threshold t_{postfilt_smax} and/or t_{postfilt_emax} may be dynamically determined based on the time it has taken in the past for RO filtration system 400 to reach α*T_{postfilt_volume}, where α is equal to 100%, 110%, or more. For example, in some embodiments, t_{postfilt_emax} may be the maximum (or minimum, or average) value between a percentage (e.g., 80%, 90%, 100%, 110% or higher) of the time it has taken (e.g., the last time) for RO filtration system 400 to reach α*T_{postfilt_volume} and a predetermined threshold (e.g., 8 months).

During step 1710, it is determined whether pre-filter cartridges 102 and 104 have been shipped or scheduled for shipping during the past q days, where q may be, e.g., 2 days (values higher than 2 day such as 3 days, or higher, or lower than 2 days, such as 1 day, or lower, may also be used). If the output of step 1710 is “yes,” step 1720 is performed.

As shown in FIGS. 13-17, some embodiments automatically ship replacement components based on outputs of various sensors of RO filtration system 400. Some embodiments may, instead or in addition to the automatic shipment of replacement components, provide an indication (e.g., a light, a sound, a text message or email, etc.) to a user (e.g., a human, an external controller, etc.) that a particular component should be replaced. For example, in some embodiments, steps 1320, 1420, 1520, 1620, and 1720, instead of or in addition to shipping the respective component, provides an indication to a user that the respective component should be replaced.

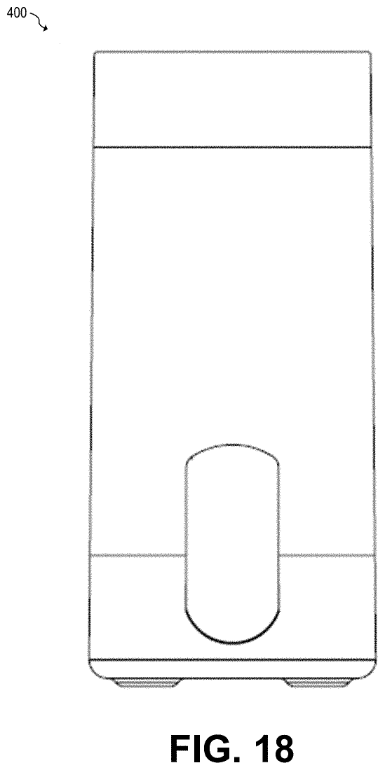

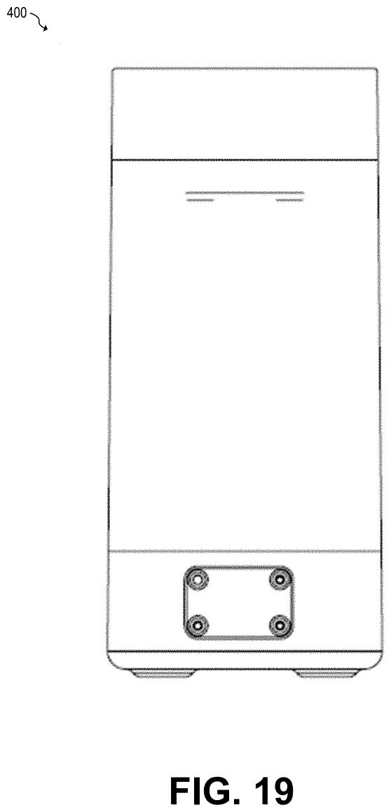

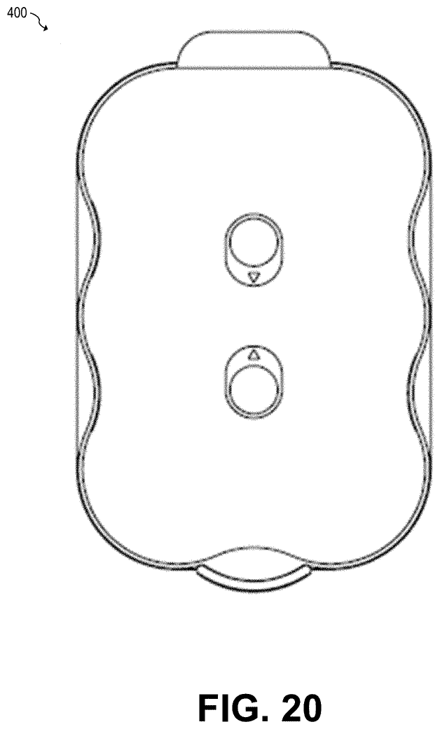

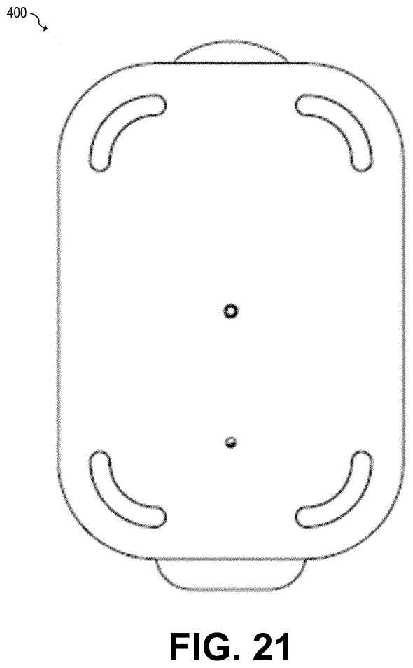

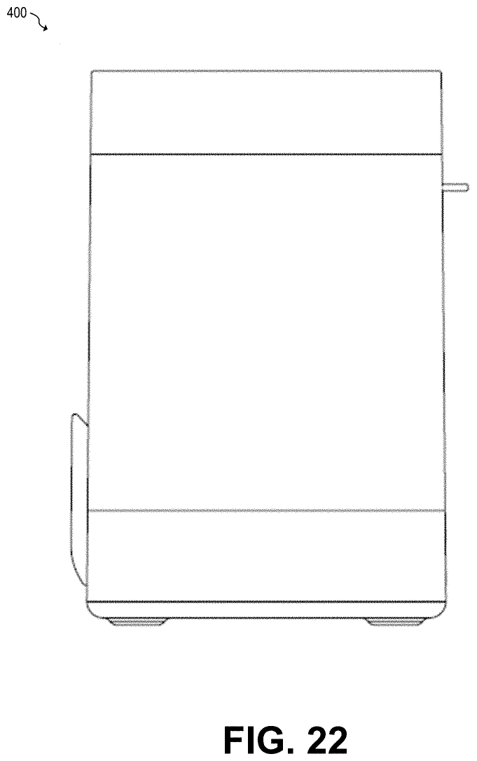

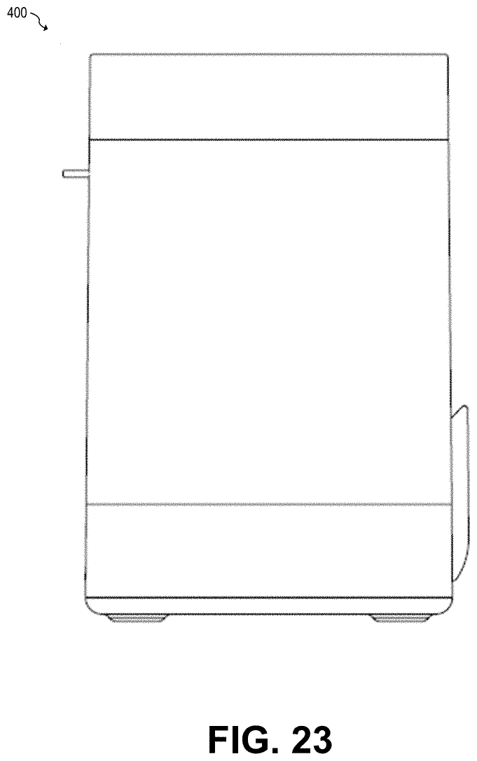

The remaining figures show various views of one example of an RO filtration system 400, according to an embodiment of the present invention. In particular, FIG. 18 shows a front view, FIG. 19 shows a back view, FIG. 20 shows a top view, FIG. 21 shows a bottom view, FIG. 22 shows a right side view, and FIG. 23 shows a left side view of an RO filtration system 400, according to an embodiment of the present invention.

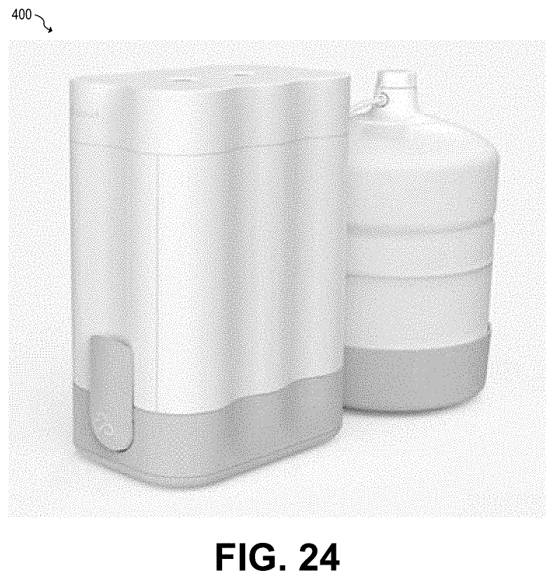

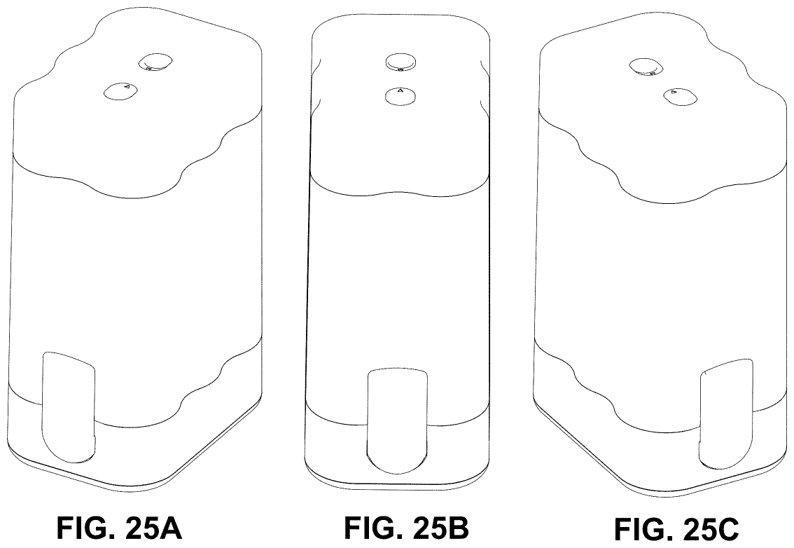

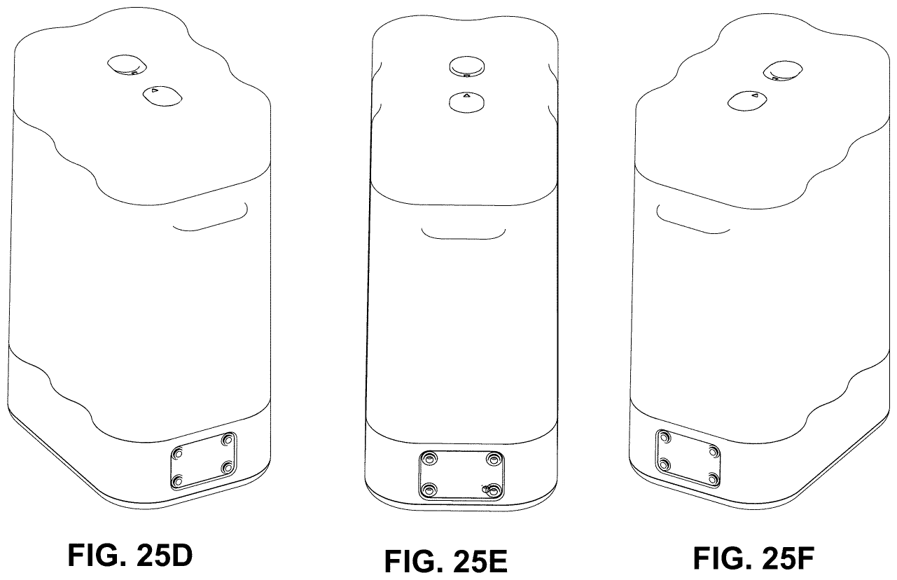

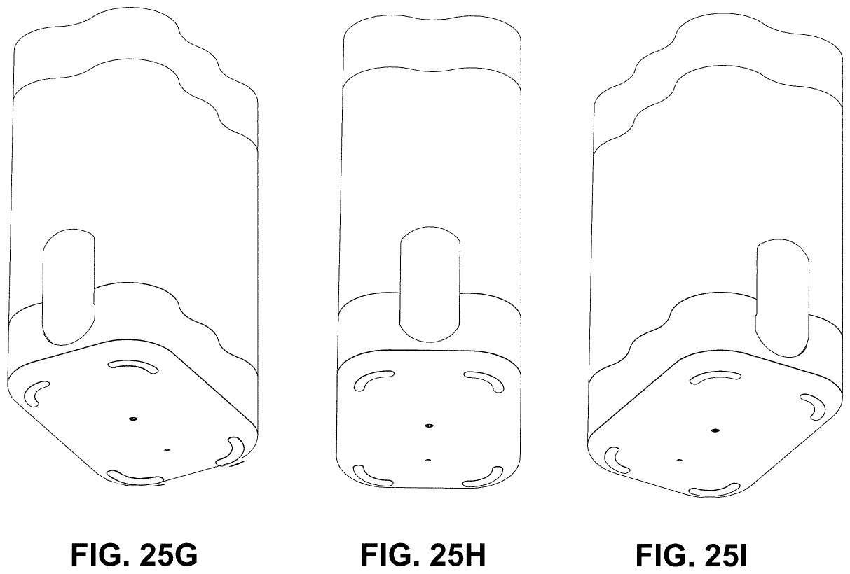

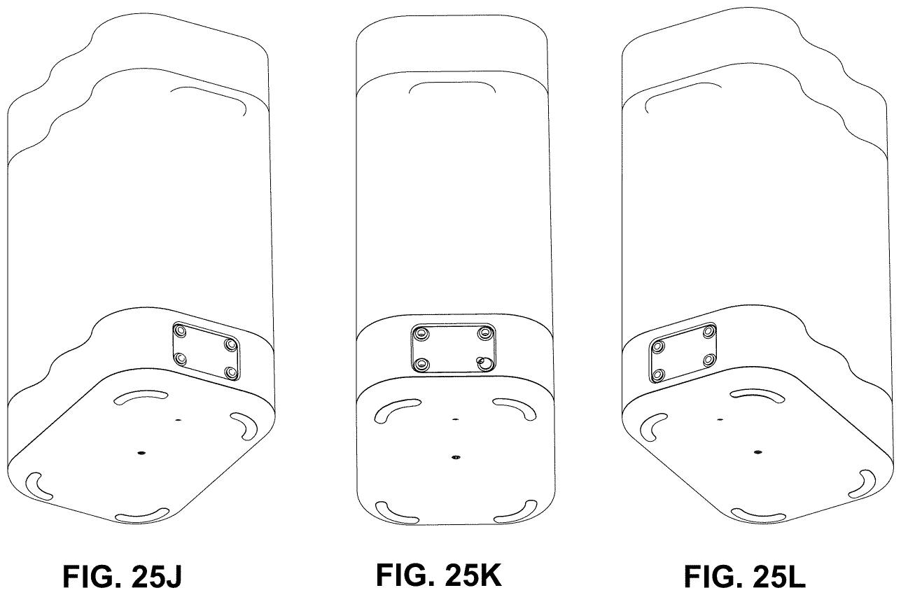

FIG. 24 shows a front perspective view of an RO filtration system 400 along with a tank. FIGS. 25A-25L show various other perspective views of the filtration system 400.

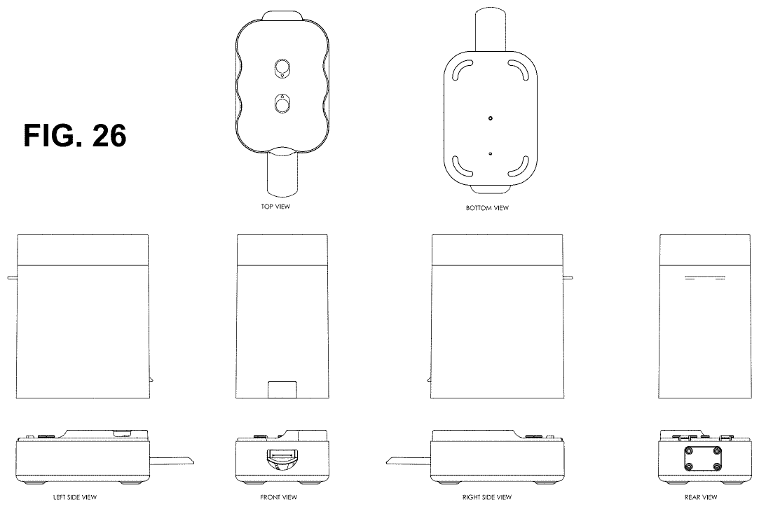

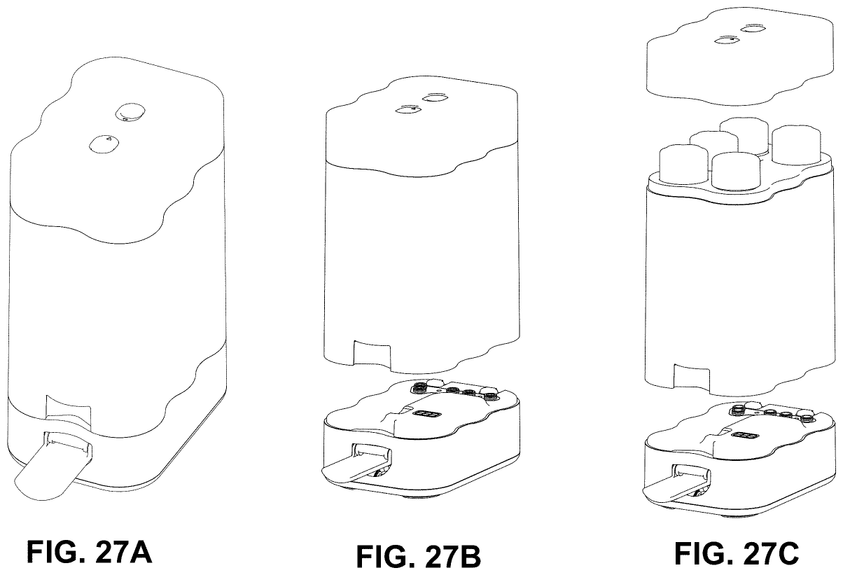

FIG. 26 shows various views of the disassembled system, while FIGS. 27A-27B provide views showing how the example system 400 can be dissembled. In FIG. 27A the latch is lowered to allow separation of the upper portion from the lower portion as shown in FIG. 27B. FIG. 27C shows that the lid can also be removed. While the upper and lower portions are disassembled in FIG. 27C, it is understood that the two disassemblies are independent.

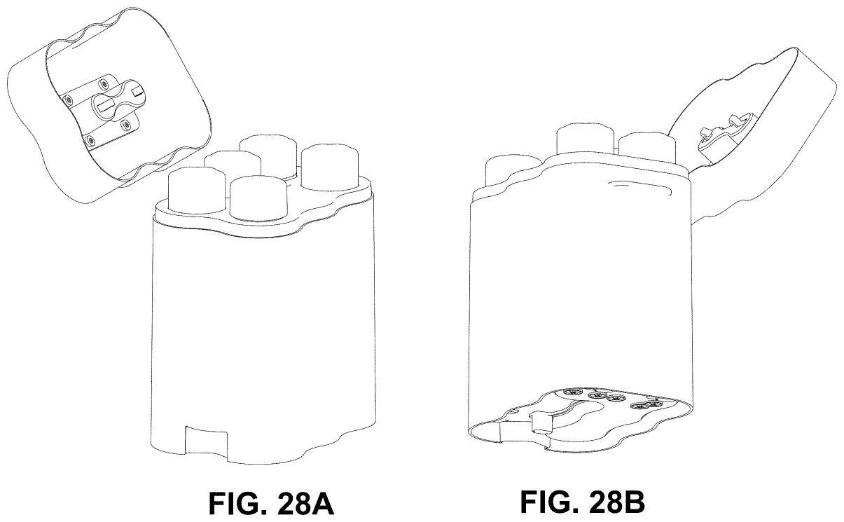

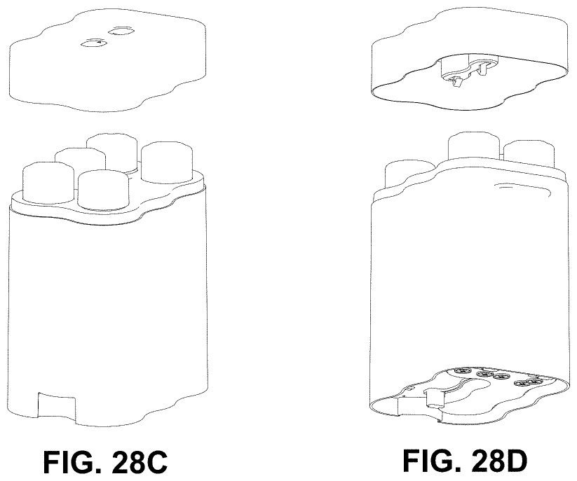

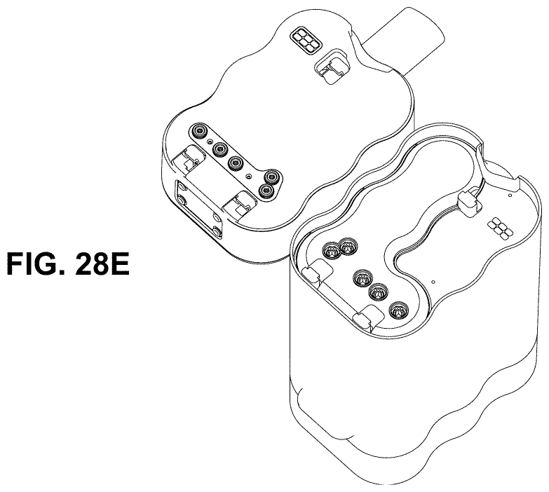

FIGS. 28A-28E show various views of the system 400 with the top detached to expose the filter stages.

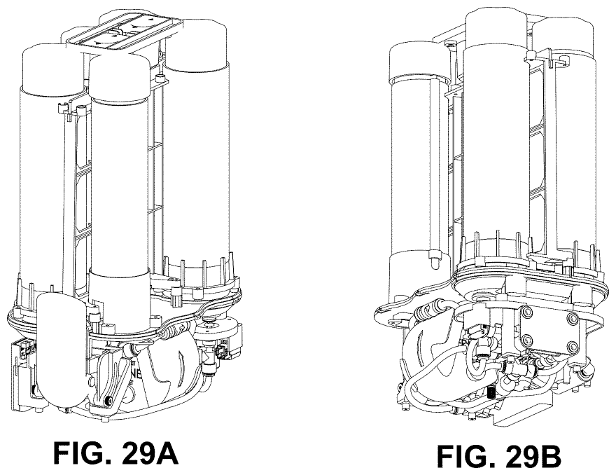

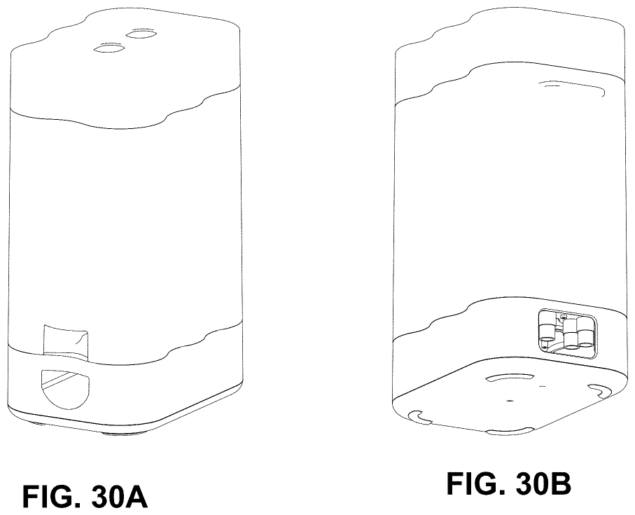

FIGS. 29A and 29B show the inside of the full enclosed system design where the tubing, permeate pump, electrical are enclosed in the base and the filter stages and battery are enclosed in magazine. FIGS. 30A and 30B show the system with the outside housing.

Example embodiments of the present invention are summarized here. Other embodiments can also be understood from the entirety of the specification and the claims filed herein.

### Example 1

A method including: determining a first value associated with a first component of a water filtration system using a first sensor of the water filtration system, determining whether the first component is degraded based on the first value, and in response to determining that the first component is degraded, initiating a shipment of a replacement component.

### Example 2

The method of example 1, further including transmitting first data based on the first value to a remote server, where determining whether the first component is degraded based on the first value comprises receiving information from the remote server, the information indicating whether the first component is degraded based on the data.

### Example 3

The method of one of examples 1 or 2, where the first sensor includes a pressure sensor monitoring a tank pressure of a water tank of the water filtration system.

### Example 4

The method of one of examples 1 to 3, where the first component includes the water tank, and where the first value includes a rate of change of tank pressure.

### Example 5

The method of one of examples 1 to 4, where determining the rate of change of tank pressure includes determining a first rate of change of tank pressure using the pressure sensor based on an output a flow switch indicative of water flow through the water filtration system, and where determining whether the first component is degraded includes comparing the first rate of change of tank pressure with a reference rate of change of tank pressure.

### Example 6

The method of one of examples 1 to 5, where the first component is a filter cartridge of the water filtration system, and where the first value includes a volume of water that has flowed through the water filtration system over a period of time.

### Example 7

The method of one of examples 1 to 6, where determining the volume of water that has flowed through the water filtration system includes estimating dispensed water based on an output a flow switch indicative of water flow through the water filtration system and on the pressure sensor.

### Example 8

The method of one of examples 1 to 7, where the first sensor includes a first TDS sensor of the water filtration system.

### Example 9

The method of one of examples 1 to 8, where the first component includes a post-filter cartridge, where the first value includes a first output TDS value associated with an output of the post-filter cartridge, and where determining whether the post-filter cartridge is degraded includes comparing the first output TDS value with a TDS value threshold, and determining that the post-filter cartridge is degraded when the first output TDS value is higher than the TDS value threshold.

### Example 10

The method of one of examples 1 to 9, further including: determining a second value associated with the first component using a second sensor of the water filtration system, where the second sensor includes a second TDS sensor, and determining a TDS rejection rate of the first component based on the first and second values, where determining whether the first component is degraded includes comparing the TDS rejection rate with a reference TDS rejection rate, and determining that the first component is degraded when the TDS rejection rate is lower than the reference TDS rejection rate.

### Example 11

The method of one of examples 1 to 10, where the first component includes an RO membrane cartridge.

### Example 12

The method of one of examples 1 to 11, where the first component includes a battery, and where the first value includes a voltage of the battery.

### Example 13

A water filtration system including: a plurality of cartridge receptacles for a plurality of cartridges, where a first cartridge receptacle of the plurality of cartridge receptacles is configured to receive a water filter cartridge, a water storage tank coupled to an output terminal of the water filtration system, a pressure sensor coupled to the water storage tank and configured to determine a tank pressure of the water storage tank, and a control circuit configured to determine whether a first component is degraded based on the tank pressure of the water storage tank, where the first component comprises one of the plurality of cartridges or the water storage tank.

### Example 14

The water filtration system of example 13, where the first component includes the water storage tank, and where the control circuit is configured to: determine a first rate of change of tank pressure using the pressure sensor based on an output a flow switch coupled to the water storage tank, compare the first rate of change of tank pressure with a reference rate of change of tank pressure, and determine that the water storage tank is degraded when the first rate of change of tank pressure is lower than the reference rate of change of tank pressure.

### Example 15

The water filtration system of examples 13 or 14, where the first component includes the water filter cartridge, and where the control circuit is configured to: determine a volume of water that has flowed through the water filter cartridge using the pressure sensor, compare the determined volume of water with a volume threshold, and determine that the water filter cartridge is degraded when the volume of water is higher than the volume threshold.

### Example 16

The water filtration system of one of examples 13 to 15, further including a first TDS sensor coupled to an output of the water filter cartridge, where the first component includes the water filter cartridge, and where the control circuit is configured to: determine a first TDS value associated with an output of the water filter cartridge, compare the first TDS value with a TDS value threshold, and determine that the water filter cartridge is degraded when the TDS value is lower than the TDS value threshold.

### Example 17

The water filtration system of one of examples 13 to 16, further including a first TDS sensor coupled to an output of the water filter cartridge, and a second TDS sensor coupled to an input of the water filter cartridge, where the first component includes the water filter cartridge, and wherein the control circuit is configured to: determine a TDS rejection rate based on the first and second TDS sensors, compare the TDS rejection rate with a TDS rejection rate threshold, and determine that the water filter cartridge is degraded when the TDS rejection rate is lower than the TDS rejection rate threshold.

### Example 18

The water filtration system of one of examples 13 to 17, further including a transceiver coupled to the control circuit, the transceiver configured to transmit a notification related to degradation of the first component.

### Example 19

The water filtration system of one of examples 13 to 18, where the transceiver is configured to communicate with a remote server to initiate a replacement for the first component.

### Example 20

The water filtration system of one of examples 13 to 19, where the transceiver is configured to transmit the notification to a UE (user equipment).

### Example 21

A method of remotely maintaining a water filtration system, the method including: receiving data at a remote server, the data received directly from the water filtration system, the data including sensor information related to a component of the water filtration system; determining, by the remote server, that the component is degraded based on the sensor information; and in response to determining that the component is degraded, shipping a replacement component to a location of the water filtration system.

### Example 22

The method of example 21, further including communicating a result of determining whether the component is degraded to communication circuitry of the water filtration system.

### Example 23

The method of example 21 or 22, where the sensor information includes information related to a water tank, the information including a rate of change of tank pressure; and where shipping the replacement component includes shipping a replacement water tank to the location of the water filtration system.

### Example 24

The method of one of examples 21 to 23, where the sensor information includes information related to filter cartridge, the information including a volume of water that has flowed through the water filtration system over a period of time; and where shipping the replacement component includes shipping a replacement filter cartridge to the location of the water filtration system.

### Example 25

The method of claim 21, wherein the sensor information comprises information related to battery, the information including a voltage of the battery; and wherein c shipping the replacement component comprises shipping a replacement battery to the location of the water filtration system.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
determining a first value associated with a first component of a water filtration system using a first sensor of the water filtration system;
determining whether the first component is degraded based on the first value; and
in response to determining that the first component is degraded, initiating a shipment of a replacement component.

2. The method of claim 1, further comprising transmitting first data based on the first value to a remote server, wherein determining whether the first component is degraded based on the first value comprises receiving information from the remote server, the information indicating whether the first component is degraded based on the first data.

3. The method of claim 1, wherein the first sensor comprises a pressure sensor monitoring a tank pressure of a water tank of the water filtration system.

4. The method of claim 3, wherein the first component comprises the water tank, and wherein the first value comprises a rate of change of tank pressure.

5. The method of claim 4, wherein determining the rate of change of tank pressure comprises determining a first rate of change of tank pressure using the pressure sensor based on an output a flow switch indicative of water flow through the water filtration system, and wherein determining whether the first component is degraded comprises comparing the first rate of change of tank pressure with a reference rate of change of tank pressure.

6. The method of claim 3, wherein the first component is a filter cartridge of the water filtration system, and wherein the first value comprises a volume of water that has flowed through the water filtration system over a period of time.

7. The method of claim 6, wherein determining the volume of water that has flowed through the water filtration system comprises estimating dispensed water based on an output a flow switch indicative of water flow through the water filtration system and on the pressure sensor.

8. The method of claim 1, wherein the first sensor comprises a first TDS sensor of the water filtration system.

9. The method of claim 8, wherein the first component comprises a post-filter cartridge, wherein the first value comprises a first output TDS value associated with an output of the post-filter cartridge, and wherein determining whether the post-filter cartridge is degraded comprises comparing the first output TDS value with a TDS value threshold, and determining that the post-filter cartridge is degraded when the first output TDS value is higher than the TDS value threshold.

10. The method of claim 8, further comprising:
determining a second value associated with the first component using a second sensor of the water filtration system, wherein the second sensor comprises a second TDS sensor; and
determining a TDS rejection rate of the first component based on the first and second values, wherein determining whether the first component is degraded comprises comparing the TDS rejection rate with a reference TDS rejection rate, and determining that the first component is degraded when the TDS rejection rate is lower than the reference TDS rejection rate.

11. The method of claim 10, wherein the first component comprises an RO membrane cartridge.

12. The method of claim 1, wherein the first component comprises a battery, and wherein the first value comprises a voltage of the battery.

13. A water filtration system comprising:
a plurality of cartridge receptacles for a plurality of cartridges, wherein a first cartridge receptacle of the plurality of cartridge receptacles is configured to receive a water filter cartridge;
a water storage tank coupled to an output terminal of the water filtration system;
a pressure sensor coupled to the water storage tank and configured to determine a tank pressure of the water storage tank; and
a control circuit configured to determine whether a first component is degraded based on the tank pressure of the water storage tank, wherein the first component comprises one of the plurality of cartridges or the water storage tank.

14. The water filtration system of claim 13, wherein the first component comprises the water storage tank, and wherein the control circuit is configured to:
determine a first rate of change of tank pressure using the pressure sensor based on an output a flow switch coupled to the water storage tank;
compare the first rate of change of tank pressure with a reference rate of change of tank pressure; and
determine that the water storage tank is degraded when the first rate of change of tank pressure is lower than the reference rate of change of tank pressure.

15. The water filtration system of claim 13, wherein the first component comprises the water filter cartridge, and wherein the control circuit is configured to:
determine a volume of water that has flowed through the water filter cartridge using the pressure sensor;
compare the determined volume of water with a volume threshold; and
determine that the water filter cartridge is degraded when the volume of water is higher than the volume threshold.

16. The water filtration system of claim 13, further comprising a first TDS sensor coupled to an output of the water filter cartridge, wherein the first component comprises the water filter cartridge, and wherein the control circuit is configured to:
determine a first TDS value associated with an output of the water filter cartridge;
compare the first TDS value with a TDS value threshold; and
determine that the water filter cartridge is degraded when the TDS value is lower than the TDS value threshold.

17. The water filtration system of claim 13, further comprising a first TDS sensor coupled to an output of the water filter cartridge, and a second TDS sensor coupled to an input of the water filter cartridge, wherein the first component comprises the water filter cartridge, and wherein the control circuit is configured to:
determine a TDS rejection rate based on the first and second TDS sensors;
compare the TDS rejection rate with a TDS rejection rate threshold; and
determine that the water filter cartridge is degraded when the TDS rejection rate is lower than the TDS rejection rate threshold.

18. The water filtration system of claim 13, further comprising a transceiver coupled to the control circuit, the transceiver configured to transmit a notification related to degradation of the first component.

19. The water filtration system of claim 18, wherein the transceiver is configured to communicate with a remote server to initiate a replacement for the first component.

20. The water filtration system of claim 18, wherein the transceiver is configured to transmit the notification to a UE (user equipment).

21. A method of remotely maintaining a water filtration system, the method comprising:
receiving data at a remote server, the data received directly from the water filtration system, the data including sensor information related to a component of the water filtration system;
determining, by the remote server, that the component is degraded based on the sensor information; and
in response to determining that the component is degraded, shipping a replacement component to a location of the water filtration system.

22. The method of claim 21, further comprising communicating a result of determining whether the component is degraded to communication circuitry of the water filtration system.

23. The method of claim 21, wherein the sensor information comprises information related to a water tank, the information including a rate of change of tank pressure; and
wherein shipping the replacement component comprises shipping a replacement water tank to the location of the water filtration system.

24. The method of claim 21, wherein the sensor information comprises information related to filter cartridge, the information including a volume of water that has flowed through the water filtration system over a period of time; and
wherein shipping the replacement component comprises shipping a replacement filter cartridge to the location of the water filtration system.

25. The method of claim 21, wherein the sensor information comprises information related to battery, the information including a voltage of the battery; and
wherein shipping the replacement component comprises shipping a replacement battery to the location of the water filtration system.
